(19) United States
(12) Patent Application Publication
(10) Pub. No.: US 2010/0179198 A1
(43) Pub. Date: Jul. 15, 2010

(54) Use of homo- and copolymers for stabilizing active ingredient formulations

(76) Inventors: Murat Mertoglu, Ludwigshafen (DE); Holger Tuerk, Mannheim (DE); Chee Chin Liew, Bad Duerkheim (DE); Ulrike Troppmann, Muenchen (DE); Reiner Weiler, Freisbach (DE); Guenter Oetter, Frankenthal (DE); Cedric Dieleman, Scheibenhard (FR); Winfried Mayer, Bubenheim (DE); Lars Vicum, Heidelberg (DE)

Correspondence Address: BRINKS, HOFER, GILSON & LIONE, P.O. BOX 1340, MORRISVILLE, NC, 27560, US

(21) Appl. No.: 12/667,052

(22) PCT Filed: Jul. 4, 2008
(86) PCT No.: PCT/EP08/58711

§ 371 Date: Dec. 29, 2009

(30) Foreign Application Priority Data
Jul. 6, 2007 (EP) 07111979.6

(51) Int. Cl. A01N 43/40; A01N 43/653; A01P 3/00

(52) U.S. Cl. 514/355; 514/383

(57) ABSTRACT

The present invention relates to the use of specific homo- and copolymers P for the stabilizing of organic active compounds in aqueous compositions or formulations comprising surface-active substances.

The present invention relates to the use of specific homo- and copolymers P for the stabilizing of organic active compounds in aqueous compositions or formulations comprising surface-active substance.

Active compounds, i.e. substances which can already display a physiological action even in a low concentration, in particular active compounds for plant protection, are frequently formulated or applied in the form of aqueous active compound compositions. Thus, for example in plant protection, the active compounds used for combating pests or for promoting growth, i.e. insecticides, fungicides, herbicides or growth regulators, are frequently formulated and sold as aqueous concentrates. For use, these formulations but also nonaqueous liquid formulations, such as emulsion concentrates, and water-dispersible powders or granules are diluted, before their application, to the desired use concentration by addition of a large amount of water (“spray mixture”). Aqueous active compound compositions have also proven to be worthwhile for pharmaceutically and cosmetically active substances and for food additives, such as vitamins, provitamins and the like.

A main problem in the formulation and use of organic active compounds in an aqueous medium is the generally low solubility in water of the active compounds, which is frequently less than 10 g/l, in particular less than 1 g/l and especially not more than 0.1 g/l at 23° C. Aqueous compositions of these active compounds are accordingly heterogeneous systems in which the active compound is present as emulsified or dispersed phase in a continuous aqueous phase. Active compound formulations usually comprise surface-active substances, such as emulsifiers, wetting agents and/or dispersants, in order to stabilize these per se metastable systems. These surface-active substances bring about, on the one hand, a reduction in the surface tension of the aqueous phase and furthermore stabilize the active compound particles in the aqueous phase by electrostatic and/or steric interactions.

Active compound formulations frequently comprise adjuvants. These are likewise surface-active substances. These adjuvants generally bring about a more uniform distribution of the organic active compound in the aqueous phase, be it in the aqueous phase of a concentrated formulation or in the spray mixture. The improved distribution of the active compound is frequently put down to a solubilizing effect of the adjuvant. With plant protection active compounds, adjuvants are also therefore frequently added in order to achieve an improved penetration of the active compound into the treated plant tissue. This is of importance in particular with plant protection active compounds possessing a systemic effect.

In spite of the use of surface-active substances, aqueous active compound formulations are frequently unstable and have a tendency towards agglomeration or crystallization of the active compound particles and consequently towards separation of the active compound distributed in the aqueous phase, for example by creaming or sedimentation. These problems are particularly pronounced if the formulation is stored for a relatively long time at elevated temperature and/or at highly changeable temperatures or in the vicinity of the freezing point. This problem is then particularly pronounced if the active compound has a tendency to crystallize, e.g. with active compounds with a low melting point (below 80° C.) and/or with active compounds exhibiting a limited solubility in the aqueous phase and/or the surface-active substance. Crystallization problems then frequently occur if the formulation comprises relatively large amounts of surface-active substances, in particular those with polyalkylene ether groups, since these can increase the solubility of the active compound in the aqueous phase and can promote crystallization or agglomeration processes.

An additional problem in the formulating of active compounds with limited or extremely low solubility in water is that, on diluting the active compound formulations to the desired use concentration, separation of the active compound can occur. This results not only in a loss in efficiency of the active substances but, with spray mixtures, the danger also exists of filter and nozzle systems becoming blocked. This problem is particularly pronounced with aqueous active compound formulations with a relatively large content of surface-active substances and/or organic cosolvents and also with emulsifiable concentrates. The separation of active compounds which occurs on diluting is naturally not limited to aqueous formulations, such as suspension concentrates (SC formulations) or microemulsion concentrates (ME formulations) but is also a problem in particular for solvent-comprising formulations, such as emulsifiable concentrates (EC formulations) or solutions of the active compounds in water-miscible solvents (DC formulations).

U.S. Pat. No. 5,205,225 describes formulations of azole fungicides which, in addition to conventional surface-active substances, comprise dimethylamides of aliphatic carboxylic acids. The dimethylamides of aliphatic carboxylic acids serve to reduce the separation of the azole fungicide on diluting the formulation.

WO 03/00716 describes liquid formulations of azole fungicides comprising polyvinyl alcohol as crystallization inhibitor.

WO 03/055944 describes the use of hydrophobically modified polymers comprising sulfonic acid groups as crystallization inhibitor in formulations comprising plant protection active compounds.

The stabilizing effect of the crystallization inhibitors known from the state of the art is frequently unsatisfactory for many active compounds with low solubilities in water, in particular if the formulation of the active compound comprises relatively large amounts of surface-active substances. This problem is then particularly pronounced if the surface-active substances present in the formulation bring about a solubilization of the active compound in the aqueous phase, e.g. in the case of nonionic surface-active substances exhibiting one or more poly-C₂-C₄-alkylene ether groups or poly-C₂-C₃-alkylene ether groups.

It is accordingly an object of the present invention to make available substances which bring about stabilization of active compounds with a low solubility in water in an aqueous phase if the aqueous phase comprises one or more surface-active substances, in particular those with a solubilizing effect for the active compound. These stabilizing substances should in particular make possible stabilization of active compounds which have a tendency to crystallize, especially of azole fungicides, fungicidal carboxamides, in particular fungicidal carboxanilides, strobilurins and the mixtures thereof.

This object is achieved, surprisingly, by homo- and copolymers P which are formed from monoethylenically unsaturated monomers M comprising:
i) at least 10% by weight, based on the total weight of the monomers M, of at least one monomer M1 chosen from acrylic acid and methacrylic acid; and
ii) up to 90% by weight, based on the total weight of the monomers M, of one or more nonionic monomers M2,
   the monomers M1 and M2 constituting at least 70% by weight of the monomers M.

The present invention correspondingly relates to the use of homo- and copolymers P, formed from monoethylenically unsaturated monomers M, comprising:
i) at least 10% by weight, based on the total weight of the monomers M, of at least one monomer M1 chosen from acrylic acid and methacrylic acid; and
ii) up to 90% by weight, based on the total weight of the monomers M, of one or more nonionic monomers M2,
   the monomers M1 and M2 constituting at least 70% by weight, in particular at least 80% by weight, preferably at least 90% by weight, particularly preferably at least 95% by weight and especially at least 99% by weight of the monomers M;
   for the stabilization in aqueous compositions comprising surface-active substances of organic active compounds which are sparingly soluble in water.

The invention is associated with a number of advantages. First, the homo- and copolymers P (subsequently also polymers P) bring about stabilization of the active compound particles distributed in the aqueous phase with regard to particle enlargement, in particular a particle enlargement caused by crystallization, with active compounds with a tendency to crystallize. In this way, they effectively counteract precipitation or separation of the active compound. In addition, at relatively high storage temperatures, in aqueous active compound compositions comprising, in addition to the active compound(s) which is/are sparingly soluble in water, at least one of the polymers P according to the invention, particle enlargement of the suspended active compound particles does not occur or occurs only very slowly or occurs to a markedly lesser extent. The stabilizing effect is in this connection not limited to aqueous formulations of the active compound comprising the active compound in concentrated form, i.e. to suspension concentrates, but also occurs in dilute active compound preparations, such as are obtained on diluting aqueous formulations, such as SC or ME formulations, or also on diluting nonaqueous liquid formulations, such as EC and DC formulations, or solid formulations, such as water-dispersible powders (WP formulations) or water-dispersible granules (WG formulations). Surprisingly, the stabilizing effect of the homo- and copolymers P also then occurs if a conventional formulation, not necessarily comprising a homo- and copolymer P, is diluted with water with addition of a homo- or copolymer P.

An additional advantage of the invention is that, in the preparation through a milling process of aqueous formulations of active compounds which are sparingly soluble in water, the expenditure of energy and time can be reduced through addition of homo- or copolymers P since the desired finely divided nature of the active compound in the formulation can generally be achieved with fewer passages or with shorter milling times, in comparison to the preparation without the addition of the at least one homo- or copolymer P.

The invention accordingly relates to formulations comprising:

a) at least one homo- or copolymer P as described here or in the claims,
b) at least one surface-active substance,
c) at least one organic active compound which is sparingly soluble in water, and
d) if appropriate water.

The invention also relates in particular to aqueous active compound compositions comprising:

a) at least one homo- or copolymer P as described here or in the claims,
b) at least one surface-active substance,
c) at least one organic active compound which is sparingly soluble in water, and
d) water.

The term “an organic active compound which is sparingly soluble in water” is understood to mean an organic compound or a mixture of different organic compounds which exhibit, in water at 23° C., a solubility generally of not more than 10 g/l, frequently of not more than 2 g/l, in particular of not more than 1 g/l and especially of not more than 0.1 g/l. Active compounds within the meaning of the present invention are chemically defined substances which selectively give rise to an effect or a reaction in an organism, generally even at small application rates. Active compounds within the meaning of this invention are in particular organic compounds with a defined molecular composition (empirical formula) and a molecular weight which is typically not more than 2000 daltons, in particular not more than 1000 daltons, and preferably lies in the range from 100 to 1000 daltons and especially in the range from 150 to 500 daltons.

The term “a composition according to the invention” is understood to mean both nonaqueous and aqueous active compound concentrates and aqueous application forms (e.g. spray mixtures) of the at least one organic active compound. The term “concentrates” is understood to mean in this connection those compositions comprising at least 1 g/l, in particular at least 10 g/l, e.g. from 10 to 800 g/l, frequently from 10 to 600 g/l or from 10 to 500 g/l, especially from 20 to 400 g/l, of the at least one organic active compound. The term “diluted application forms” is accordingly understood to mean aqueous compositions which are obtained by diluting an aqueous or nonaqueous active compound concentrate with water and which accordingly exhibit an active compound concentration generally of less than 10 g/l, e.g. from 0.0001 to <10 g/l, frequently of less than 5 g/l or of less than 1 g/l, e.g. from 0.0005 to <5 g/l or from 0.001 to <1 g/l.

The polymers used according to the invention are homo- or copolymers P which comprise, copolymerized, acrylic acid or methacrylic acid or a mixture of these acids (subsequently monomers M1) in an amount of at least 10% by weight, in particular of at least 20% by weight, preferably of at least 30% by weight, particularly preferably of at least 40% by weight and especially of at least 50% by weight. The proportion of the monomers M1, based on the total amount of the monomers M constituting the homo- or copolymer, can be up to 100% by weight. In this case, homo- or copolymers of the monomers M1 are concerned which consist exclusively of the monomers M1.

In a preferred embodiment of the invention, use is made of copolymers which, in addition to the abovementioned monomers M1, comprise, copolymerized, at least 1 additional monomer M2. In these copolymers, the proportion of the monomers M2 is from 1 to 90% by weight, in particular from 2 to 80% by weight, particularly preferably from 5 to 70% by weight, particularly preferably from 10 to 60% by weight and especially from 10 to 50% by weight, based on the total weight of the monomers M. The proportion of the copolymerized monomers M1 in these copolymers accordingly lies in the range from 10 to 99% by weight, in particular from 20 to 98% by weight, particularly preferably from 30 to 95% by weight, particularly preferably from 40 to 90% by weight and especially from 50 to 90% by weight.

The total amount of the monomers M1 and M2 constitutes, according to the invention, at least 70% by weight, frequently at least 80% by weight, preferably at least 90% by weight, in particular at least 95% by weight, particularly preferably at least 99% by weight and especially 100% by weight of the monoethylenically unsaturated monomers M constituting the homo- or copolymer P. Preferably, the homo- and copolymers P according to the invention comprise less than 5% by weight, based on the total amount of the monomers M, and in particular no or less than 0.5% by weight, copolymerized, of monomers with phosphonic acid groups or sulfonic acid groups.

Preference is given, among the monomers M1, to methacrylic acid.

Preference is given, among the monomers M2, to those monomers exhibiting at least a limited solubility in water, generally a solubility in water of at least 1 g/l, frequently of at least 5 g/l, preferably of at least 10 g/l and in particular of at least 20 g/l, at 25° C. Examples of such monomers M2 are
C₁-C₄-alkyl acrylates and methacrylates, such as methyl acrylate, methyl methacrylate, ethyl acrylate and n-butyl acrylate;
hydroxyalkyl acrylates and methacrylates, in particular hydroxy-C₂-C₃-alkyl acrylates and methacrylates, such as 2-hydroxyethyl acrylate, 2-hydroxypropyl acrylate, 3-hydroxypropyl acrylate, 2-hydroxyethyl methacrylate, 2-hydroxypropyl methacrylate and 3-hydroxypropyl methacrylate;
amides, N—C₁-C₄-alkylamides and N,N-di-C₁-C₄-alkylamides of acrylic acid or of methacrylic acid, such as acrylamide, methacrylamide, N,N-dimethylacrylamide or N,N-dimethylmethacrylamide;
vinyl esters of aliphatic carboxylic acids with preferably 1 to 3 carbon atoms, such as vinyl acetate and vinyl propionate;
vinyl ethers, in particular vinyl C₁-C₄-alkyl ethers, such as vinyl methyl ether, vinyl ethyl ether and the like;
and also N-vinyllactams, preferably those with 3 to 5 carbon atoms in the lactam ring, such as N-vinylpyrrolidone, N-vinylpiperidone and N-vinylcaprolactam.

The monomers M2 can also comprise smaller amounts of monomers with a low solubility in water generally of less than 5 g/l, in particular of less than 1 g/l, at 25° C.). These monomers with a low solubility in water are preferably used, for the preparation of the polymers P, in combination with monomers M2 exhibiting a limited solubility in water (at least 1 g/l, frequently at least 5 g/l, preferably at least 10 g/l and in particular at least 20 g/l at 25° C.). The proportion of the monomers with low solubility in water will generally not exceed 20% by weight, based on the total amount of the monomers M. Examples of monomers with low solubility in water are:
C₅-C₂₀-alkyl acrylates and methacrylates, such as n-hexyl acrylate, n-octyl acrylate, n-decyl acrylate, 2-ethylhexyl acrylate, 2-propylheptyl acrylate, lauryl acrylate, stearyl acrylate, n-hexyl methacrylate, n-octyl methacrylate, n-decyl methacrylate, 2-ethylhexyl methacrylate, 2-propylheptyl methacrylate, lauryl methacrylate and stearyl methacrylate;
vinylaromatic monomers, such as styrene and vinyltoluene,
N-C₅-C₂₀-alkylamides and N—C₁-C₁₀-alkyl-N-C₅-C₂₀-alkylamides of acrylic acid or of methacrylic acid, such as N-hexylacrylamide, N;
vinyl esters of aliphatic carboxylic acids with preferably 4 to 20 carbon atoms, such as vinyl laurate and vinyl stearate;
vinyl ethers, in particular vinyl C₄-C₂₀-alkyl ethers, such as vinyl hexyl ether, vinyl decyl ether, vinyl octadecyl ether and the like;
and also olefins with 2 to 20 carbon atoms, such as ethene, propene, 1-butene, isobutene, n-hexene, diisobutene, and trimers and tetramers of butene or isobutene.

In a first embodiment of the invention, the monomers M2 are chosen from monomers with a limited solubility in water generally of not more than 60 g/l, e.g. from 1 to 60 g/l, in particular from 10 to 60 g/l, at 25° C. These include N—C₁-C₃-alkylamides of acrylic acid or of methacrylic acid, N,N-di-C₁-C₃-alkylamides of acrylic acid or of methacrylic acid, vinyl esters of aliphatic C₁-C₃-carboxylic acids, C₁-C₃-alkyl vinyl ethers and C₁-C₄-alkyl acrylates and C₁-C₄-alkyl methacrylates, C₁-C₄-alkyl acrylates and C₁-C₄-alkyl methacrylates being preferred. The monomers M2 are particularly preferably chosen from methyl acrylate and methyl methacrylate and the mixtures thereof and the mixtures thereof with up to 20% by weight of monomers with low solubility in water.

In another (second) embodiment, the monomers M2 are chosen from monomers with an extensive or complete solubility in water generally of at least 60 g/l, in particular of at least 80 g/l, at 25° C. These include in particular the abovementioned hydroxyalkyl acrylates, hydroxyalkyl methacrylates and N-vinyllactams.

In a third embodiment, the polymer P is formed exclusively from acrylic acid, methacrylic acid or a mixture of these acids.

In a fourth embodiment, the polymer P is formed from monomers M comprising methacrylic acid as monomer M1 and methyl acrylate, methyl methacrylate or mixtures thereof as monomer M2. In particular, the polymer P is formed exclusively of methacrylic acid and methyl acrylate, methyl methacrylate or mixtures thereof. Preferably, the ratio by weight of monomer M1 to monomer M2 in the polymers P of this embodiment ranges from 50:1 to 1:5, in particular from 20:1 to 1:1 and especially from 10:1 to 2:1.

Preference is given, according to the invention, to those homo- or copolymers P exhibiting a weight-average molecular weight in the range from 500 to 200 000 daltons, in particular from 1000 to 70 000 daltons and particularly preferably from 2000 to 30 000 daltons. The molecular weight can be determined in a way known per se by light scattering or gel permeation chromatography according to methods known per se. An indirect measurement for the molecular weight is the “K value” according to Fikentscher (H. Fikentscher, Cellulose-Chemie [Cellulose Chemistry], Volume 13, pages 58-64 and 71-74 (1932)). The K value, determined as a 0.1% by weight solution of the homo- or copolymer P in 0.1 M aqueous sodium chloride solution or in a mixture of 0.1 M aqueous sodium chloride solution and methanol, generally lies in the range from 5 to 100, frequently in the range from 7 to 80, in particular in the range from 10 to 50 and especially in the range from 12 to 40.

The homo- and copolymers P are preferably used, for the stabilization of the active compound, in acidic or in particular in partially neutralized form. Preferably, the degree of neutralization of the homo- and copolymers P, i.e. the proportion of the neutralized carboxyl groups which result from the copolymerized acrylic acid or methacrylic acid, is not greater than 90%, in particular not greater than 80%, preferably not greater than 70%, especially not greater than 50%. In particular, the degree of neutralization is >0 up to 70%, preferably >0 up to 50% and particularly preferably >0 up to 30%, e.g. from 1 to 70%, preferably from 1 to 50%, in particular from 1 to 30%, above all between 0 and 30%, e.g. from 1 to 29%. Use may in principle be made, for the neutralization, of all bases suitable for the neutralization of carboxyl groups. Examples of suitable bases are alkali metal hydroxides, alkali metal carbonates, alkali metal hydrogencarbonates, ammonia and organic amines. Preferred bases are alkali metal hydroxides and alkali metal carbonates, in particular sodium hydroxide or potassium hydroxide. In addition, it is possible, in the preparation of the homo- and copolymers P, to start from neutralized or partially neutralized acrylic acid or methacrylic acid.

The homo- and copolymers P can be prepared according to conventional methods by radical polymerization of the monomers M. The polymerization can be carried out by free radical polymerization or by controlled radical polymerization processes. The polymerization can be carried out using one or more initiators and as solution polymerization, as emulsion polymerization, as suspension polymerization, as precipitation polymerization or as bulk polymerization. The polymerization can be carried out batchwise, semicontinuously or continuously.

The reaction times generally lie in the range between 1 and 12 hours. The temperature range in which the reactions can be carried out generally extends from 20 to 200° C., preferably from 40 to 120° C. The polymerization pressure is of secondary importance and can be carried out in the range from standard pressure or slight negative pressure, e.g. >800 mbar, or under positive pressure, e.g. up to 10 bar, it being possible for higher or lower pressures likewise to be used.

Conventional radical-forming substances are used as initiators for the radical polymerization. Preference is given to choosing initiators from the groups of the azo compounds, of the peroxide compounds and of the hydroperoxide compounds. The peroxide compounds include, for example, acetyl peroxide, benzoyl peroxide, lauroyl peroxide, tert-butylperoxy isobutyrate or caproyl peroxide. In addition to hydrogen peroxide, the hydroperoxides also include organic peroxides, such as cumene hydro-peroxide, tert-butyl hydroperoxide, tert-amyl hydroperoxide and the like. The azo compounds include, for example, 2,2′-azobisisobutyronitrile, 2,2′-azobis(2-methyl-butyronitrile), 2,2′-azobis[2-methyl-N-(2-hydroxyethyl)propionamide], 1,1′-azobis(1-cyclohexanecarbonitrile), 2,2′-azobis(2,4-dimethylvaleronitrile) or 2,2′-azobis(N,N′-dimethyleneisobutyroamidine). Azobisisobutyronitrile (AIBN) is particularly preferred. The initiator is normally used in an amount of from 0.02 to 5% by weight and in particular from 0.05 to 3% by weight, based on the amount of the monomers M, it also being possible to use larger amounts, e.g. up to 30% by weight, for example in the case of hydrogen peroxide. The optimum amount of initiator naturally depends on the initiator system used and can be determined by a person skilled in the art in routine experiments.

The initiator can be partially or completely introduced into the reaction vessel. Preferably, the bulk of the initiator, in particular at least 80%, e.g. from 80 to 100%, of the initiator, is added to the polymerization reactor in the course of the polymerization.

The molecular weight of the homo- and copolymers P can self-evidently be adjusted by addition of a small amount of regulators, e.g. from 0.01 to 5% by weight, based on the polymerizing monomers M. Suitable regulators are in particular organic thio compounds, e.g. mercaptoalcohols, such as mercaptoethanol, mercaptocarboxylic acids, such as thioglycolic acid or mercaptopropionic acid, or alkyl mercaptans, such as dodecyl mercaptan, and furthermore allyl alcohols and aldehydes.

The homo- and copolymers P are prepared in particular by radical solution polymerization in an organic solvent or solvent mixture. Examples of organic solvents are alcohols, such as, e.g., methanol, ethanol, n-propanol and isopropanol, dipolar aprotic solvents, e.g. N-alkyllactams, such as N-methylpyrrolidone (NMP) or N-ethylpyrrolidone, furthermore dimethyl sulfoxide (DMSO) or N,N-dialkylamides of aliphatic carboxylic acids, such as N,N-dimethylformamide (DMF) or N,N-dimethyl-acetamide, or furthermore aromatic, aliphatic and cycloaliphatic hydrocarbons which may be halogenated, such as hexane, chlorobenzene, toluene or benzene, and mixtures thereof. Preferred solvents are isopropanol, methanol, toluene, DMF, NMP, DMSO and hexane. Isopropanol is particularly preferred. Furthermore, the homo- and copolymers P can be prepared in a mixture with water of the solvents and solvent mixtures described previously. The proportion of water in these mixtures is, in this connection, preferably less than 50% by volume and in particular less than 10% by volume.

If appropriate, the actual polymerization can be followed by a postpolymerization, e.g. by addition of a redox initiator system. The redox initiator systems are composed of at least one generally inorganic reducing agent and one inorganic or organic oxidizing agent. The oxidizing components are, e.g., the peroxide compounds already mentioned above. The reducing components are, e.g., alkali metal salts of sulfurous acid, such as, e.g., sodium sulfite or sodium hydrogensulfite, alkali metal salts of disulfurous acid, such as sodium disulfite, bisulfite addition compounds of aliphatic aldehydes and ketones, such as acetone bisulfite, or reducing agents, such as hydroxymethanesulfinic acid and the salts thereof, or ascorbic acid. The redox initiator systems can be used in combination with soluble metal compounds, the metal components of which can occur in several valency states. Conventional redox initiator systems are, e.g., ascorbic acid/iron(II) sulfate/sodium peroxodisulfate, tert-butyl hydroperoxide/sodium disulfite, tert-butyl hydroperoxide/sodium hydroxymethanesulfinate. The individual components, e.g. the reducing component, can also be mixtures, e.g. a mixture of the sodium salt of hydroxymethanesulfinic acid and sodium disulfite.

The applicable homo- and copolymers P according to the invention are generally used in an amount of at least 1% by weight, preferably of at least 5% by weight and in particular of at least 10% by weight, based on the active compound(s) to be stabilized. Preferably, the homo- and copolymers P are used in an amount of 5 to 2000% by weight, frequently of 10 to 1000% by weight, preferably of 10 to 500% by weight or of 10 to 100% by weight, in particular in an amount of 10 to 60% by weight, based on the active compound(s). In aqueous active compound formulations, the concentration of the homo- or copolymers P typically lies in the range from 0.01 to 15% by weight, in particular in the range from 0.1 to 10% by weight and especially in the range from 0.5 to 6% by weight, based on the total weight of the aqueous composition.

In the aqueous active compound preparations which can be obtained by diluting, the homo- or copolymer P is generally used in an amount of 0.05 to 20 parts by weight, preferably in an amount of 0.1 to 10 parts by weight, based on 1 part by weight of the active compound. Generally, the active compound preparations which can be obtained by diluting with water comprise the polymer P in an amount of 0.01 to 5% by weight, in particular of 0.1 to 3% by weight, based on the total weight of the active compound preparation.

According to a preferred embodiment of the invention, the homo- and copolymer P is applied together with at least one surface-active substance. These include conventional surface-active substances, such as nonionic and anionic emulsifiers and protective colloids, and furthermore solubilizing polymers, such as are used, as is known, for the stabilization of active compounds in the aqueous phase. Emulsifiers/surfactants and protective colloids are known to a person skilled in the art, e.g. from H. Mollet et al, Formulation Technology, pp. 27-24 and pp. 65-73, Wiley-VCH, Weinheim 2001, and R. Heusch, Emulsions in Ullmann's Encyclopedia of Industrial Chemistry, 5th ed. on CD-Rom, Wiley-VCH 1998.

Examples of conventional surface-active substances are the nonionic, anionic, cationic or zwitterionic emulsifiers, wetting agents or dispersants given below, e.g. the nonionic substances from groups b1) to b16):
b1) aliphatic C₈-C₃₀-alcohols, which can be alkoxylated, e.g. with from 1 to 60 alkylene oxide units, preferably from 1 to 60 EO and/or from 1 to 30 PO and/or from 1 to 15 BO, in any sequence. In this connection, EO is a repeat unit derived from ethylene oxide, PO is a repeat unit derived from propylene oxide and BO is a repeat unit derived from butylene oxide. The terminal hydroxyl groups of these compounds can be end group closed by an alkyl, cycloalkyl or acyl radical with from 1 to 24, in particular from 1 to 4, carbon atoms. Examples of such compounds are: Genapol®C, L, O, T, UD, UDD and X products from Clariant, Plurafac® and Lutensol®A, AT, ON and TO products from BASF SE, Marlipal® 24 and 013 products from Condea, Dehypon® products from Henkel and Ethylan® products from Akzo-Nobel, such as Ethylan CD 120;
b2) copolymers composed of EO, PO and/or BO units, in particular EO/PO block copolymers, such as the Pluronic® products from BASF SE and the Synperonic® products from Uniquema, with a molecular weight of generally from 400 to 10⁶ daltons (number-average), in particular from 1000 to 100 000 daltons and especially in the range from 1500 to 80 000 daltons, and also alkylene oxide adducts of C₁-C₈-alcohols, such as Atlox®5000 from Uniquema or Hoe® S3510 from Clariant, with a molecular weight of generally from 400 to 10⁶ daltons (number-average), in particular from 1000 to 100 000 daltons and especially in the range from 1500 to 80 000 daltons;
b3) fatty acid and triglyceride alkoxylates, such as the Serdox® NOG products from Condea, and also alkoxylated vegetable oils, such as soybean oil, rapeseed oil, corn oil, sunflower oil, cottonseed oil, linseed oil, coconut oil, palm oil, thistle oil, walnut oil, peanut oil, olive oil or castor oil, in particular rapeseed oil, for example the Emulsogen® products from Clariant;
b4) fatty acid amide alkoxylates, such as the Comperlan® products from Henkel or the Amam® products from Rhodia;
b5) alkylene oxide adducts of alkynediols, such as the Surfynol® products from Air Products. Sugar derivatives, such as amino- and amidosugars from Clariant. Glucitols from Clariant, alkylpolyglycosides in the form of the APG® products from Henkel or such as sorbitan esters in the form of the Span® or Tween® products from Uniquema or cyclodextrin esters or ethers from Wacker;
b6) surface-active cellulose and algin, pectin and guar derivatives, such as the Tylose® products from Clariant, the Manutex® products from Kelco and guar derivatives from Cesalpina;
b7) alkylene oxide adducts based on polyols, such as Polyglykol® products from Clariant;
b8) surface-active polyglycerides and the derivatives thereof from Clariant;
b9) sugar surfactants, e.g. alkoxylated sorbitan fatty acid esters, alkylpolyglycosides and the alkoxylated derivatives thereof;
b10) alkylene oxide adducts of fatty amines;
b11) surface-active compounds based on silicones or silanes, such as the Tegopren® products from Goldschmidt and the SE® products from Wacker, and also the Bevaloid®, Rhodorsil® and Silcolapse® products from Rhodia (Dow Corning, Reliance, GE, Bayer);
b12) per- or polyfluorinated surface-active compounds, such as the Fluowet® products from Clariant, the Bayowet® products from Bayer, the Zonyl® products from DuPont and products of this type from Daikin and Asahi Glass;
b13) surface-active sulfonamides, e.g. from Bayer;
b14) neutral surface-active polyvinyl compounds, such as modified polyvinyl-pyrrolidone, such as the Luviskol® products from BASF and the Agrimer® products from ISP, or derivatized poly(vinyl acetate)s, such as the Mowilith® products from Clariant, or poly(vinyl butyrate)s, such as the Lutonal® products from BASF, the Vinnapas® and the Pioloform® products from Wacker, or modified poly(vinyl alcohol)s, such as the Mowiol® products from Clariant, and surface-active derivatives of montan, polyethylene and polypropylene waxes, such as the Hoechst® waxes or the Licowet® products from Clariant;
b15) poly- or perhalogenated phosphonates and phosphinates, such as Fluowet® PL from Clariant;
b16) poly- or perhalogenated neutral surfactants, such as, for example, Emulsogen® 1557 from Clariant;
b17) (poly)alkoxylated, in particular polyethoxylated, aromatic compounds, such as (poly)alkoxylated phenols [=phenol (poly)alkylene glycol ethers], for example with from 1 to 50 alkyleneoxy units in the (poly)alkyleneoxy part, the alkylene part preferably exhibiting from 2 to 4 carbon atoms each time, preferably phenol reacted with from 3 to 10 mol of alkylene oxide, (poly)alkylphenol alkoxylates [=polyalkylphenol (poly)alkylene glycol ethers], for example with from 1 to 12 carbon atoms per alkyl radical and from 1 to 150 alkyleneoxy units in the polyalkyleneoxy part, preferably tri(n-butyl)phenol or triisobutylphenol reacted with from 1 to 50 mol of ethylene oxide, polyarylphenols or polyarylphenol alkoxylates [=polyarylphenol (poly)alkylene glycol ethers], for example tristyryl-phenol polyalkylene glycol ethers with from 1 to 150 alkyleneoxy units in the polyalkyleneoxy part, preferably tristyrylphenol reacted with from 1 to 50 mol of ethylene oxide, and the condensation products thereof with formaldehyde—preference is given among these to alkylphenol reacted with from 4 to 10 mol of ethylene oxide, available commercially, for example, in the form of the Agrisol® products (Akcros), triisobutylphenol reacted with from 4 to 50 mol of ethylene oxide, available commercially, for example, in the form of the Sapogenat® T products (Clariant), nonylphenol reacted with from 4 to 50 mol of ethylene oxide, available commercially, for example, in the form of the Arkopal® products (Clariant), or tristyrylphenol reacted with from 4 to 150 mol of ethylene oxide, for example from the Soprophor® series, such as Soprophor® FL, Soprophor® 3D33, Soprophor® BSU, Soprophor® 4D-384, Soprophor® CY/8 (Rhodia);
   the anionic substances from the groups b18 to b24:
b18) anionic derivatives of the products described under b1) in the form of ether carboxylates, sulfonates, sulfates (=sulfuric acid hemiesters) and phosphates (phosphoric acid mono- or diesters) of the substances described under b1) and the inorganic salts (e.g., NH₄⁺, alkali metal and alkaline earth metal salts) and organic salts (e.g., based on amines or alkanolamines) thereof, such as Genapol®LRO, Sandopan® products, Hostaphat/Hordaphos® products from Clariant;
b19) anionic derivatives of the products described under b17) in the form of ether carboxylates, sulfonates, sulfates (=sulfuric acid hemiesters) and phosphates (phosphoric acid mono- or diesters) of the substances described under b17), for example the acidic phosphoric acid ester of a C₁-C₁₆-alkylphenol ethoxylated with from 2 to 10 mol of ethylene oxide, e.g. the acidic phosphoric acid ester of a nonylphenol reacted with 3 mol or with 9 mol of ethylene oxide, and the phosphoric acid ester, neutralized with triethanolamine, of the reaction product of 20 mol of ethylene oxide and 1 mol of tristyrylphenol;
b20) benzenesulfonates, such as alkyl- or arylbenzenesulfonates, e.g. (poly)alkyl- and (poly)arylbenzenesulfonates which are acidic and neutralized with suitable bases, for example with from 1 to 12 carbon atoms per alkyl radical or with up to 3 styrene units in the polyaryl radical, preferably (linear) dodecylbenzenesulfonic acid and the oil-soluble salts thereof, such as, for example, the calcium salt or the isopropylammonium salt of dodecylbenzenesulfonic acid, and acidic (linear) dodecylbenzenesulfonate, available commercially, for example, in the form of the Marlon® products (Hüls);
b21) lignosulfonates, such as sodium, calcium or ammonium lignosulfonates, such as Ufoxane® 3A, Borresperse AM® 320 or Borresperse® NA;
b22) condensation products of arylsulfonic acids, such as phenolsulfonic acid or naphthalenesulfonic acid, with formaldehyde and, if appropriate, urea, in particular the salts thereof and especially the alkali metal salts and calcium salts, e.g. the Tamol® and Wettol® brands from BASF SE, such as Wettol® D1;
b23) salts of aliphatic, cycloaliphatic and olefinic carboxylic acids and polycarboxylic acids, and also α-sulfo fatty acid esters, such as are available from Henkel;
b24) alkanesulfonates, paraffinsulfonates and olefinsulfonates, such as Netzer IS®, Hoe® S1728, Hostapur®OS, Hostapur®SAS from Clariant;
   furthermore cationic and zwitterionic products from groups b25) and b26):
b25) quaternary ammonium compounds with from 8 to 22 carbon atoms (C₈-C₂₂), such as, e.g., the Genamin® C, L, O and T products from Clariant;
b26) surface-active, zwitterionic compounds, such as taurides, betaines and sulfobetaines in the form of Tegotain® products from Goldschmidt, Hostapon® and Arkopon® T products from Clariant.

Preference is given, among the alkyleneoxy units or alkylene ether units, to ethyleneoxy, propyleneoxy and butyleneoxy units, in particular ethyleneoxy units and mixtures of ethyleneoxy units and propyleneoxy units. The term “alkoxylated” means that the surface-active substance exhibits a polyalkylene ether group, in particular a poly-C₂-C₄-alkylene ether group, especially a poly-C₂-C₃-alkylene ether group. The number of alkyleneoxy units in the polyalkyleneoxy or polyalkylene ether groups in the substances from groups b1), b3), b4), b5), b7), b9), b10), b11), b17), b18) and b19) typically ranges from 2 to 150, in particular from 2 to 100, especially from 3 to 60 (number-average).

Preferred conventional nonionic surface-active substances are the substances mentioned under b1), in particular ethoxylated and/or propoxylated C₈-C₂₄-alkanols, the substances mentioned in group b2), in particular EO/PO block copolymers, the substances mentioned in group b3), in particular alkoxylated vegetable oils, the substances mentioned in group b4), the substances mentioned in group b9), the substances mentioned in group b10) and the substances mentioned in group b17), in particular ethoxylated and/or propoxylated alkylphenols.

Preferred conventional anionic surface-active substances are the substances mentioned under b18), b19), b22) and b23), in particular the substances mentioned under b22) and b23).

Solubilizing polymers within the meaning of the invention are those polymers which result in an extremely fine, i.e. nanodisperse, distribution of the active compound in the aqueous phase, so that the apparent particle size of the active compound particles is clearly below 1000 nm, typically not more than 500 nm, frequently not more than 400 nm, in particular not more than 300 nm, particularly preferably not more than 250 nm, very particularly preferably not more than 200 nm, e.g. in the range from 5 to 400 nm, frequently in the range from 10 to 300 nm, preferably in the range from 10 to 250 nm, in particular in the range from 20 to 200 nm. According to the type of the solubilizing polymer and of the active compound or effect compound and also depending on the ratios of concentrations, the aggregates can also become so small that they no longer exist in the form of detectable discrete particles (particle size <20 nm, <10 nm or <5 nm). The particle sizes given here are volume-average particle sizes, such as can be determined by light scattering. Methods for this are familiar to a person skilled in the art, for example from H. Wiese in D. Distler, Wässrige Polymerdispersionen [Aqueous Polymer Dispersions], Wiley-VCH 1999, chapter 4.2.1, pp. 40ff, and the literature cited therein, and also H. Auweter and D. Horn, J. Colloid Interf. Sci., 105 (1985), 399, D. Lilge and D. Horn, Colloid Polym. Sci., 269 (1991), 704, or H. Wiese and D. Horn, J. Chem. Phys., 94 (1991), 6429.

According to a preferred embodiment of the invention, the aqueous composition of the active compound to be stabilized comprises at least one surface-active substance exhibiting one or more poly-C₂-C₄-alkylene ether groups. These include, in particular, nonionic emulsifiers exhibiting one or more poly-C₂-C₄-alkylene ether groups and also solubilizing polymers exhibiting one or more poly-C₂-C₄-alkylene ether groups. The number of C₂-C₄-alkyleneoxy units in the poly-C₂-C₄-alkylene ether groups in the substances from groups b1), b3), b4), b5), b7), b9), b10), b11), b17), b18) and b19) typically ranges from 2 to 150, in particular from 2 to 100, especially from 3 to 60 (number-average). Preference is given, among these, to those substances in which the alkyleneoxy units of the poly-C₂-C₄-alkylene ether groups are chosen from 1,2-ethyleneoxy units and 1,2-propyleneoxy units and mixtures thereof.

Suitable solubilizing polymers are in particular block copolymers exhibiting one or more poly-C₂-C₄-alkylene ether groups and at least one polymer chain formed from mono-ethylenically unsaturated monomers. The blocks can be connected directly to one another, i.e. via a chemical bond, or can be connected to one another via a spacer, i.e. via a polyvalent organic radical. Polyvalent means in this connection that the organic radical exhibits, on average, at least 1.5, in particular at least two, bonding positions, e.g. 1.5 to 6 or 2 to 4 bonding positions.

In a preferred embodiment of the invention, the block copolymers are those in which at least one poly-C₂-C₄-alkylene ether group is connected, via a spacer exhibiting urethane groups, to at least one polymer chain formed from monoethylenically unsaturated monomers. Such block copolymers are known, for example, from WO 2005/121201 and WO 2006/084680, to the disclosure of which reference is made herewith.

In the block copolymers, the polymer chain formed from monoethylenically unsaturated monomers (subsequently polymer chain P1) typically exhibits a number-average molecular weight in the range from 500 to 20 000 daltons and in particular in the range from 1500 to 15 000 daltons.

In the block copolymers, the poly-C₂-C₄-alkylene ether group (subsequently polymer chain P2) generally exhibits a number-average molecular weight, determined by means of GPC according to standard methods, in the range from 500 to 20 000 daltons and in particular in the range from 800 to 15 000 daltons.

The overall proportion of the polymer chain P1 in the block copolymer is preferably from 9 to 90% by weight and in particular from 20 to 68% by weight of the total weight of polymer chain P1, polymer chain P2 and, if appropriate, spacer.

The overall proportion of the polyether P2 in the block copolymer is preferably from 9 to 90% by weight and in particular from 30 to 78% by weight of the total weight of polymer chain P1, polymer chain P2 and, if appropriate, spacer.

The overall proportion of the spacer in the block copolymer will generally not exceed 20% by weight, based on the total weight of the block copolymer, and is, if a spacer is present, frequently from 1 to 20% by weight and in particular from 2 to 15% by weight of the total weight of polymer chain P1, polymer chain P2 and spacer.

The ratio by weight of polymer chain P1 to poly-C₂-C₄-alkylene ether group P2 in the block copolymers preferably lies in the range from 1:10 to 10:1 and in particular in the range from 1:5 to 5:1.

Suitable as constituent monomers for the polymer chain P1 formed from monoethylenically unsaturated monomers (subsequently monomers M′) are in particular neutral monoethylenically unsaturated monomers Ma with a limited solubility in water generally of not more than 60 g/l at 25° C. (hydrophobic monomers) and monomers Mb with an increased solubility in water.

The monomers M′ preferably comprise
from 20 to 100% by weight, or from 20 to 99% by weight, in particular from 50 to 100% by weight or from 50 to 95% by weight, of at least one monomer Ma and
from 0 to 80% by weight, or from 1 to 80% by weight, in particular from 0 to 50% by weight or from 5 to 50% by weight, of one or more monomers Mb,
   the figures in % by weight being based on the total amount of the monomers M′.

Examples of monomers Ma are
i) esters of monoethylenically unsaturated C₃-C₈-carboxylic acids with C₁-C₂₀-alkanols, C₆-C₁₀-cycloalkanols, phenyl-C₁-C₆-alkanols or phenoxy-C₂-C₆-alkanols, in particular the acrylic acid or methacrylic acid esters of the abovementioned alcohols, the esters of acrylic acid or of methacrylic acid with C₁-C₂₀-alkanols (C₁-C₂₀-alkyl acrylates or C₁-C₂₀-alkyl methacrylates), such as methyl acrylate, ethyl acrylate, n-butyl acrylate, isobutyl acrylate, tert-butyl acrylate, n-hexyl acrylate, 2-ethylhexyl acrylate, 3-propylheptyl acrylate, methyl methacrylate, ethyl methacrylate, n-butyl methacrylate, isobutyl methacrylate, tert-butyl methacrylate, n-hexyl methacrylate, lauryl acrylate, lauryl methacrylate, isotridecyl acrylate, isotridecyl methacrylate, stearyl acrylate and stearyl methacrylate, being particularly preferred. Esters of acrylic acid or of methacrylic acid with 2-phenoxyethanol, such as 2-phenoxyethyl acrylate, are likewise preferred,
ii) N—(C₂-C₁₀-alkyl)amides of monoethylenically unsaturated C₃-C₈-carboxylic acids, especially of acrylic acid and of methacrylic acid, and also the N—(C₁-C₂-alkyl)-N—(C₂-C₁₀-alkyl)amides of monoethylenically unsaturated C₃-C₈-carboxylic acids, especially of acrylic acid and of methacrylic acid, e.g. N-ethylacrylamide, N,N-diethylacrylamide, N-butylacrylamide, N-methyl-N-propylacrylamide, N-(n-hexyl)acrylamide, N-(n-octyl)acrylamide and the corresponding methacrylamides,
iii) vinylaromatic monomers, such as styrene, α-methylstyrene, vinyltoluene, and the like,
iv) olefins with from 2 to 20 carbon atoms, preferably α-olefins with from 3 to 10 carbon atoms, such as propene, 1-butene, 1-pentene, 1-hexene, 1-octene, diisobutene and 1-decene,
v) vinyl esters of aliphatic carboxylic acids, such as vinyl acetate, vinyl propionate, vinyl laurate, vinyl nonanoate, vinyl decanoate, vinyl laurate and vinyl stearate,
vi) halogenated olefins, such as vinyl chloride,
vii) di-C₁-C₂₀-alkyl esters of ethylenically unsaturated dicarboxylic acids with preferably from 4 to 8 carbon atoms, e.g. di-C₁-C₂₀-alkyl esters of fumaric acid and of maleic acid, such as dimethyl fumarate, dimethyl maleate, dibutyl fumarate and dibutyl maleate,
viii) glycidyl esters of monoethylenically unsaturated monocarboxylic acids with preferably from 3 to 6 carbon atoms, such as glycidyl acrylate and glycidyl methacrylate.

Preference is given, among the monomers Ma, to those from groups i), ii) and iii).

In particular, the monomers Ma comprise at least 50% by weight, in particular at least 70% by weight, based on the total amount of the monomers Ma, of at least one monomer chosen from C₁-C₄-alkyl acrylates, C₁-C₄-alkyl methacrylates and styrene, and particularly preferably among these methyl methacrylate, tert-butyl methacrylate, styrene and the mixtures thereof.

Preferred monomers Ma are also mixtures of the abovementioned monomers Ma which predominantly comprise, in particular at least 60% by weight and particularly preferably 70% by weight, e.g. from 60 to 99% by weight or from 70 to 99% by weight, based on the total amount of the monomers Ma, at least one first monomer Ma chosen from C₁-C₄-alkyl acrylates, C₁-C₄-alkyl methacrylates and styrene, and also at least one monomer Ma differing therefrom, e.g. a C₅-C₂₀-alkyl acrylate or C₅-C₂₀-alkyl methacrylate and/or a monomer from the group iii).

The monoethylenically unsaturated monomers Mb can be basic or cationic, acidic or anionic, or nonionic, i.e. electrically neutral.

The neutral monomers Mb include, for example:
amides and C₁-C₄-alkyloxyalkylamides of monoethylenically unsaturated C₃-C₈-monocarboxylic acids, such as acrylamide, methacrylamide, N-(methoxymethyl)-(meth)acrylamide, N-(ethoxymethyl)(meth)acrylamide, N-(2-methoxyethyl)(meth)acrylamide, N-(2-ethoxyethyl)(meth)acrylamide and the like;
monoethylenically unsaturated nitriles, such as acrylonitrile and methacrylonitrile;
N-vinylamides of aliphatic, cycloaliphatic or aromatic carboxylic acids, in particular N-vinylamides of aliphatic carboxylic acids with from 1 to 4 carbon atoms, such as N-vinylformamide, N-vinylacetamide, N-vinylpropionamide and N-vinylbutyramide;
N-vinyllactams with from 5 to 7 ring atoms, e.g. N-vinylpyrrolidone, N-vinyl-piperidone, N-vinylmorpholinone and N-vinylcaprolactam;
monoethylenically unsaturated monomers carrying urea groups, such as N-vinyl- and N-allylurea and also derivatives of imidazolidin-2-one, e.g.
   N-vinyl- and N-allylimidazolidin-2-one,
   N-vinyloxyethylimidazolidin-2-one,
   N-allyloxyethylimidazolidin-2-one
   N-(2-acrylamidoethyl)imidazolidin-2-one,
   N-(2-acryloyloxyethyl)imidazolidin-2-one,
   N-(2-methacrylamidoethyl)imidazolidin-2-one,
   N-(2-methacryloyloxyethyl)imidazolidin-2-one (=ureido methacrylate),
   N-[2-(acryloyloxyacetamido)ethyl]imidazolidin-2-one,
   N-[2-(2-acryloyloxyacetamido)ethyl]imidazolidin-2-one,
   N-[2-(2-methacryloyloxyacetamido)ethyl]imidazolidin-2-one;
monoethylenically unsaturated monomers exhibiting aldehyde or keto groups, such as 3-(acrylamido)-3-methylbutan-2-one (diacetone acrylamide), 3-(methacrylamido)-3-methylbutan-2-one, 2,4-dioxopentyl acrylate and 2,4-dioxopentyl methacrylate.

The basic monomers Mb include, for example:
vinyl-substituted nitrogen heteroaromatic compounds, such as 2-, 3- and 4-vinyl-pyridine or N-vinylimidazole; and
monoethylenically unsaturated monomers with a primary, secondary or tertiary amino group, in particular monomers of the general formula I

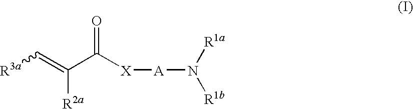

in which
X is oxygen or an N—R^{4a} group;
A is C₂-C₈-alkylene, e.g. 1,2-ethanediyl, 1,2- or 1,3-propanediyl, 1,4-butanediyl or 2-methyl-1,2-propanediyl, which is, if appropriate, interrupted by 1, 2 or 3 nonneighboring oxygen atoms, such as in 3-oxapentane-1,5-diyl;
R^{1a} and R^{1b} are, independently of one another, hydrogen, C₁-C₁₀-alkyl, C₅-C₁₀-cycloalkyl, phenyl or phenyl-C₁-C₄-alkyl and in particular both are each C₁-C₄-alkyl;
R^{2a} is hydrogen or C₁-C₄-alkyl, in particular hydrogen or methyl;
R^{3a} is hydrogen or C₁-C₄-alkyl and in particular hydrogen; and
R^{4a} is hydrogen or C₁-C₄-alkyl and in particular hydrogen.

Examples of monomers of the formula I are 2-(N,N-dimethylamino)ethyl acrylate, 2-(N,N-dimethylamino)ethyl methacrylate, 2-(N,N-dimethylamino)ethylacrylamide, 3-(N,N-dimethylamino)propyl acrylate, 3-(N,N-dimethylamino)propyl methacrylate, 3-(N,N-dimethylamino)propylacrylamide, 3-(N,N-dimethylamino)propylmethacrylamide and 2-(N,N-dimethylamino)ethylmethacrylamide, 3-(N,N-dimethylamino)propyl methacrylate being particularly preferred.

The monomers Mb furthermore include anionic or acidic monoethylenically unsaturated monomers. Examples of these are:
monoethylenically unsaturated monomers exhibiting a sulfonic acid group, and also the salts of such monomers, in particular the alkali metal salts, e.g. the sodium or potassium salts, and also the ammonium salts. These include ethylenically unsaturated sulfonic acids, in particular vinylsulfonic acid, 2-acrylamido-2-methylpropanesulfonic acid, 2-acryloyloxyethanesulfonic acid and 2-methacryloyloxyethanesulfonic acid, 3-acryloyloxy- and 3-methacryloyloxypropanesulfonic acid, vinylbenzenesulfonic acid and the salts thereof;
ethylenically unsaturated phosphonic acids, such as vinylphosphonic acid and vinylphosphonic acid dimethyl ester and the salts thereof; and
monoethylenically unsaturated monomers carrying one or two carboxyl groups, e.g. α,β-ethylenically unsaturate C₃-C₈-monocarboxylic and C₄-C₈-dicarboxylic acids, in particular acrylic acid, methacrylic acid, crotonic acid, maleic acid, fumaric acid and itaconic acid.

Preferred acid monomers Mb are the abovementioned monoethylenically unsaturated monomers with one or two carboxyl groups.

The polymers P2 are linear or branched poly-C₂-C₄-alkylene ethers, thus polymers, which are essentially, i.e. to at least 90% by weight, based on the weight of the polymers P2 formed from repeat units of the formula II

[—A—O—] (II)

in which A is a C₂-C₄-alkylene group, such as ethane-1,2-diyl, propane-1,2-diyl, propane-1,3-diyl, butane-1,2-diyl or butane-1,3-diyl. Preference is given, among the polymers P2, to those which are formed, to at least 50% by weight, advantageously at least 70% by weight, in particular at least 80% by weight and especially to at least 90% by weight, of ethylene oxide units, i.e. from groups of the formula II in which A is 1,2-ethanediyl. In addition, the aliphatic polyethers can exhibit structural units derived from C₃-C₄-alkylene oxides.

Particularly preferred polyethers P2 are those of the general formula III

R^{a}—X—(CHR^{b}—CH₂—O)ₚ—H (III)

in which
R^{a} is hydrogen, C₁-C₂₀-alkyl or benzyl,
X is oxygen or NH,
R^{b} is hydrogen or methyl, at least 50 mol %, in particular at least 70 mol % and preferably at least 90 mol % of the R^{b} groups being hydrogen,
p is an integer, the average value of which lies in the range from 10 to 500, preferably from 20 to 250 and in particular from 25 to 100 (number-average).

Suitable polyethers P2 are known to the person skilled in the art and are for the most part commercially available, for example under the Pluriol® and Pluronic® trade names (Polyethers from BASF-Aktiengesellschaft).

In the block copolymers, the polyether chains P1 and P2 can be directly connected to one another, i.e. via a chemical bond, or can be connected to one another via a spacer, the latter being preferred. The polymer chains P1 and P2 are then generally connected to one another with the spacer via functional groups, e.g. via ester, amide, urea, thiourea or urethane groups.

Suitable as spacers are in particular polyvalent aliphatic, cycloaliphatic, aromatic or araliphatic hydrocarbon radicals with generally from 2 to 20 carbon atoms which are connected to the polymer chains P1 and P2 via the abovementioned functional groups. Generally, the spacer exhibits, on average, at least 1.5, in particular at least 2, e.g. from 1.5 to 6, in particular from 2 to 4, valencies, so that the block copolymers exhibit, on average, at least 1.5, in particular at least 2, e.g. from 1.5 to 6, in particular from 2 to 4, polymer chains P1 or P2.

According to a preferred embodiment of the block copolymers, the polymer chains P1 and P2 are each connected to a spacer via a urethane group or urea group. Such block copolymers can be obtained by successively or simultaneously reacting the OH- or NH₂-functionalized polymers P1 and P2 with a polyisocyanate compound V preferably exhibiting a functionality, with regard to the isocyanate groups, of at least 1.5, in particular of 1.5 to 6 and especially of 2 to 4. Examples of suitable polyisocyanate compounds V are aliphatic, cycloaliphatic and aromatic di- and polyisocyanates and also the isocyanurates, allophanates, uretdiones and biurets of aliphatic, cycloaliphatic and aromatic diisocyanates.

Preferably, the compounds V exhibit, on average, from 2 to 4 isocyanate groups per molecule. Examples of suitable compounds V are aromatic diisocyanates, such as toluene 2,4-diisocyanate, toluene 2,6-diisocyanate, commercially available mixtures of toluene 2,4- and 2,6-diisocyanate (TDI), m-phenylene diisocyanate, 3,3′-diphenyl-4,4′-biphenylene diisocyanate, 4,4′-biphenylene diisocyanate, 4,4′-diphenylmethane diisocyanate, 3,3′-dichloro-4,4′-biphenylene diisocyanate, cumene 2,4-diisocyanate, 1,5-naphthalene diisocyanate, p-xylylene diisocyanate, p-phenylene diisocyanate, 4-methoxy-1,3-phenylene diisocyanate, 4-chloro-1,3-phenylene diisocyanate, 4-ethoxy-1,3-phenylene diisocyanate, 2,4-dimethyl-1,3-phenylene diisocyanate, 5,6-dimethyl-1,3-phenylene diisocyanate, 2,4-diisocyanatodiphenyl ether, aliphatic diisocyanates, such as ethylene diisocyanate, ethylidene diisocyanate, propylene 1,2-diisocyanate, 1,6-hexamethylene diisocyanate, 1,4-tetramethylene diisocyanate or 1,10-decamethylene diisocyanate, and cyclo-aliphatic diisocyanates, such as isophorone diisocyanate (IPDI), cyclohexylene 1,2-diisocyanate, cyclohexylene 1,4-diisocyanate and bis(4,4′-isocyanatocyclohexyl)-methane. Preference is given, among the diisocyanates, to those having isocyanate groups which differ in their reactivity, such as toluene 2,4-diisocyanate, IPDI, the mixtures thereof and cis- and trans-isophorone diisocyanate.

In another preferred embodiment of the invention, use is made, in the preparation of the block copolymers, of a biuret or an isocyanurate of an aliphatic or cycloaliphatic diisocyanate compound, for example the cyanurate of tetramethylene diisocyanate or of hexamethylene diisocyanate.

Reference should be made to WO 2005/121201 and WO 2006/084680 for further details.

The compositions to be stabilized can, in place of or together with the block copolymers, comprise further also conventional surface-active substances. Suitable in particular are anionic surface-active substances, e.g. those from groups b18) to b24), in particular from groups b18), b19), b22) and b23), and nonionic emulsifiers, in particular nonionic emulsifiers exhibiting at least one poly-C₂-C₄-alkylene ether group, and anionic emulsifiers, in particular nonionic emulsifiers from groups b1), b2), b4), b9), b10) and b17), and copolymers from group b3).

In contrast to polymeric surface-active substances, such as protective colloids and the solubilizing block copolymers defined here, emulsifiers typically exhibit a molecular weight of not more than 2000 daltons and in particular of not more than 1000 daltons.

The anionic emulsifiers include the substances mentioned in groups b18) to b24), in particular the abovementioned carboxylates, in particular alkali metal, alkaline earth metal and ammonium salts of fatty acids, e.g. potassium stearate, which are usually also described as soaps; acylglutamates; sarcosinates, e.g. sodium lauroylsarcosinate; taurates; methylcelluloses; alkyl phosphates, in particular alkyl monophosphates and alkyl diphosphates; sulfates, in particular alkyl sulfates and alkyl ether sulfates; sulfonates, further alkyl- and alkylarylsulfonates, in particular alkali metal, alkaline earth metal and ammonium salts of arylsulfonic acids and alkyl-substituted arylsulfonic acids, alkylbenzenesulfonic acids, such as, for example, ligno-fonic acid and phenol-sulfonic acid, naphthalene- and dibutylnaphthalenesulfonic acids, or dodecylbenzene-sulfonates, alkylnaphthalenesulfonates, alkyl methyl ester sulfonates, condensation products of sulfonated naphthalene and derivatives thereof with formaldehyde, condensation products of naphthalenesulfonic acids, phenol- and/or phenolsulfonic acids with formaldehyde or with formaldehyde and urea, or monoalkyl or dialkyl sulfosuccinates; and also protein hydrolysates and lignin sulfite waste liquors. The abovementioned sulfonic acids are advantageously used in the form of their neutral or, if appropriate, basic salts.

The nonionic surfactants with poly-C₂-C₄-alkylene ether groups include in particular:
substances from group b1), such as fatty alcohol C₂-C₃-alkoxylates and oxo alcohol C₂-C₃-alkoxylates, in particular ethoxylates and ethoxylate-co-propoxylates with degrees of alkoxylation of usually from 2 to 100 and in particular from 3 to 50, e.g. alkoxylates, in particular ethoxylates and propoxylates, of C₈-C₃₀-alkanols or alk(adi)enols, e.g. of iso-tridecyl alcohol, lauryl alcohol, oleyl alcohol or stearyl alcohol, and the C₁-C₄-alkyl ethers and C₁-C₄-alkyl esters thereof, e.g. the acetates thereof;
substances from group b2), in particular ethylene oxide-propylene oxide block copolymers;
substances from group b3), such as alkoxylated, in particular ethoxylated and/or propoxylated, animal and/or vegetable fats and/or oils, for example corn oil ethoxylates, castor oil ethoxylates or tallow fat ethoxylates,
substances from group b17), such as alkylphenol C₂-C₃-alkoxylates, in particular alkylphenol ethoxylates and alkylphenol ethoxylate-co-propoxylates, such as, for example, ethoxylated iso-octyl, octyl- or nonylphenol, or tributylphenol polyoxyethylene ether,
substances from groups b4) and b9), such as fatty amine C₂-C₃-alkoxylates, in particular fatty amine ethoxylates and fatty amine ethoxylate-co-propoxylates, and also fatty acid amide alkoxylates and fatty acid diethanolamide alkoxylates, in particular the ethoxylates thereof,
substances from group b10), sugar surfactants with poly-C₂-C₃-alkylene ether groups, e.g. polyoxyethylene sorbitan fatty acid esters, ethoxylated alkylpolyglycosides and ethoxylated N-alkylgluconamides.

The compositions to be stabilized according to the invention generally comprise at least one surface-active substance in an amount of from 0.05 to 20 parts by weight, frequently from 0.1 to 10 parts by weight, in particular from 0.2 to 8 parts by weight and especially from 0.5 to 5 parts by weight, based on 1 part by weight of the active compound to be stabilized. In aqueous active compound formulations, the total concentration of the surface-active substance(s) typically lies in the range from 1 to 50% by weight, in particular in the range from 1 to 45% by weight and especially in the range from 1 to 40% by weight, based on the total weight of the aqueous composition.

In a preferred embodiment of the invention, the compositions to be stabilized according to the invention comprise at least one solubilizing polymer, in particular one of the abovementioned block copolymers, and, if appropriate, one or more conventional surface-active substances differing therefrom, in particular a nonionic surface-active substance. The proportion of the solubilizing polymers, in particular of the abovementioned block copolymers, in the total amount of the surface-active substance(s) present in the composition is typically at least 50% by weight, in particular at least 80% by weight.

In another preferred embodiment of the invention, the compositions to be stabilized according to the invention comprise at least one conventional surface-active substance, in particular one conventional nonionic surface-active substance exhibiting a poly-C₂-C₄-alkylene oxide group, in particular at least one nonionic surface-active substance chosen from the substances mentioned in groups b1), b2), b3), b4), b9), b10) and b17) and especially from the substances mentioned in groups b1), b2) and b17), and, if appropriate, one or more conventional anionic surface-active substances, in particular at least one from the substances mentioned groups b18), b22) and b23). The proportion of the at least one nonionic surface-active substance in the total amount of the surface-active substance(s) present in the composition is typically at least 20% by weight, in particular at least 30% by weight. The ratio by weight of conventional surface-active substances to active compound typically lies in this embodiment in the range from 1:20 to 20:1, in particular in the range from 1:10 to 10:1.

According to a preferred embodiment of the invention, the active compounds are active compounds for plant protection, in particular insecticidal and/or fungicidal active compounds. In particular, the compositions to be stabilized according to the invention comprise at least one active compound which has a tendency to crystallize. In these compositions, the homo- and copolymers used according to the invention result in a clearly reduced tendency of the active compound to crystallize.

Examples of fungicidal active compounds which can be formulated using the homo- or copolymers P according to the invention comprise the following organic compounds:
Strobilurins
e.g., azoxystrobin, dimoxystrobin, enestroburin, fluoxastrobin, kresoxim-methyl, metominostrobin, picoxystrobin, pyraclostrobin, trifloxystrobin, orysastrobin, methyl (2-chloro-5-[1-(3-methylbenzyloxyimino)ethyl]benzyl)carbamate, methyl (2-chloro-5-[1-(6-methylpyridin-2-ylmethoxyimino)ethyl]benzyl)carbamate, methyl 2-(ortho-(2,5-dimethylphenyloxymethyl)phenyl)-3-methoxyacrylate;
Carboxamides
   carboxanilides, such as, e.g., benalaxyl, benodanil, bixafen, boscalid, carboxin, mepronil, fenfuram, fenhexamid, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-(trifluoromethyl)-biphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide, N-(3′,4′,5′-trifluorobiphenyl-2-yl)-3-difluoromethyl-1-methyl-1H-pyrazole-4-carboxamide, N-[2-(4′-trifluoromethylthio)biphenyl]-3-difluoromethyl-1-methyl-1H-pyrazole-4-carboxamide, N-[2-(1,3-dimethylbutyl)phenyl]-1,3-dimethyl-5-fluoro-1H-pyrazole-4-carboxamide, N-[2-(bicyclopropyl-2-yl)phenyl]-3-difluoromethyl-1-methyl-1H-pyrazole-4-carboxamide, N-[2-(cis-2-bicyclopropyl-2-yl)phenyl]-3-difluoromethyl-1-methyl-1H-pyrazole-4-carboxamide, N-[2-(trans-2-bicyclopropyl-2-yl)phenyl]-3-difluoromethyl-1-methyl-1H-pyrazole-4-carboxamide, N-[1,2,3,4-tetrahydro-9-(1-methylethyl)-1,4-methanonaphth-5-yl]-3-difluoromethyl-1-methyl-1H-pyrazole-4-carboxamide;
   carboxylic acid morpholides, such as, e.g., dimethomorph, flumorph;
   benzamides, such as, e.g., flumetover, fluopicolide (picobenzamid), zoxamide;
   other carboxamides, such as, e.g., carpropamid, diclocymet, mandipropamid, ethaboxam, penthiopyrad, N-(2-(4-(4-[3-(4-chlorophenyl)prop-2-ynyloxy]-3-methoxyphenypethyl)-2-methanesulfonylamino-3-methylbutyramide, N-(2-(4-[3-(4-chlorophenyl)prop-2-ynyloxy]-3-methoxyphenypethyl)-2-ethanesulfonylamino-3-methylbutyramide;
Azoles
   triazoles, such as, e.g., bitertanol, bromuconazole, cyproconazole, difenoconazole, diniconazole, enilconazole, epoxiconazole, fenbuconazole, flusilazole, fluquinconazole, flutriafol, hexaconazole, imibenconazole, ipconazole, metconazole, myclobutanil, penconazole, propiconazole, prothioconazole, simeconazole, tebuconazole, tetraconazole, triadimenol, triadimefon, triticonazole;
   imidazoles, such as, e.g., cyazofamid, imazalil, pefurazoate, prochloraz, triflumizole;
   benzimidazoles, such as, e.g., benomyl, carbendazim, fuberidazole, thiabendazole;
   and others, such as ethaboxam, etridiazole, hymexazole;
Nitrogen-comprising heterocyclyl compounds, e.g.,
   pyridines, such as, e.g., fluazinam, pyrifenox, 3-[5-(4-chlorophenyl)-2,3-dimethylisoxazolidin-3-yl]pyridine;
   pyrimidines, such as, e.g., bupirimate, cyprodinil, ferimzone, fenarimol, mepanipyrim, nuarimol, pyrimethanil;
   piperazines, such as triforine;
   pyrroles, such as fludioxonil, fenpiclonil;
   morpholines, such as aldimorph, dodemorph, fenpropimorph, tridemorph;
   dicarboximides, such as iprodione, procymidone, vinclozolin;
   others, such as acibenzolar-S-methyl, anilazine, captan, captafol, dazomet, diclomezine, fenoxanil, folpet, fenpropidin, famoxadone, fenamidone, octhilinone, probenazole, proquinazid, pyroquilon, quinoxyfen, tricyclazole, 6-aryl-[1,2,4]triazolo[1,5-a]pyrimidines, e.g. 5-chloro-7-(4-methylpiperidin-1-yl)-6-(2,4,6-trifluorophenyl)-[1,2,4]triazolo[1,5-a]pyrimidine, 2-butoxy-6-iodo-3-propylchromen-4-one, N,N-dimethyl-3-(3-bromo-6-fluoro-2-methylindole-1-sulfonyl)-[1,2,4]triazole-1-sulfonamide;
Carbamates and dithiocarbamates
   dithiocarbamates, such as ferbam, mancozeb, maneb, metiram, metam, propineb, thiram, zineb, ziram;
   carbamates, such as diethofencarb, benthiavalicarb, iprovalicarb, propamocarb, methyl 3-(4-chlorophenyl)-3-(2-isopropoxycarbonylamino-3-methylbutyrylamino)propionate, 4-fluorophenyl N-(1-(1-(4-cyanophenyl)-ethanesulfonyl)but-2-yl)carbamate;
Other fungicides
   guanidines, such as dodine, iminoctadine, guazatine;
   antibiotics, such as kasugamycin, polyoxins, streptomycin, validamycin A;
   organometallic compounds, such as fentin salts;
   sulfur-comprising heterocyclyl compounds, such as isoprothiolane, dithianon;
   organophosphorus compounds, such as edifenphos, fosetyl, fosetyl-aluminum, iprobenfos, pyrazophos, tolclofos-methyl, phosphorous acid and its salts;
   organochlorine compounds, such as thiophanate-methyl, chlorothalonil, dichlofluanid, tolylfluanid, flusulfamide, phthalide, hexachlorobenzene, pencycuron, quintozene;
   nitrophenyl derivatives, such as binapacryl, dinocap, dinobuton;
   others, such as, e.g., spiroxamine, cyflufenamid, cymoxanil, metrafenon.

Examples of herbicidal active compounds which can be formulated using the homo- or copolymers P according to the invention comprise:
1,3,4-thiadiazoles, such as buthidazole and cyprazole;
amides, such as allidochlor, benzoylpropethyl, bromobutide, chlorthiamid, dimepiperate, dimethenamid, diphenamid, etobenzanid, flamprop-methyl, fosamine, isoxaben, metazachlor, monalide, naptalam, pronamide, propanil;
aminophosphoric acids, such as bilanafos, buminafos, glufosinate-ammonium, glyphosate, sulfosate;
aminotriazoles, such as amitrole;
anilides, such as anilofos, mefenacet;
aryloxyalkanoic acids, such as 2,4-D, 2,4-DB, clomeprop, dichlorprop, dichlorprop-P, fenoprop, fluoroxypyr, MCPA, MCPB, mecoprop, mecoprop-P, napropamide, naproanilide, triclopyr;
benzoic acids, such as chloramben, dicamba;
benzothiadiazinones, such as bentazon;
bleachers, such as clomazone, diflufenican, fluorochloridone, flupoxam, fluridone, pyrazolate, sulcotrione;
carbamates, such as carbetamide, chlorbufam, chlorpropham, desmedipham, phenmedipham, vernolate;
quinolinic acids, such as quinclorac, quinmerac;
dichloropropionic acids, such as dalapon;
dihydrobenzofurans, such as ethofumesate;
dihydrofuran-3-ones, such as flurtamone;
dinitroanilines, such as benefin, butralin, dinitramine, ethalfluralin, fluchloralin, isopropalin, nitralin, oryzalin, pendimethalin, prodiamine, profluralin, trifluralin;
dinitrophenols, such as bromofenoxim, dinoseb, dinoseb acetate, dinoterb, DNOC, medinoterb acetate;
diphenyl ethers, such as acifluorfen-sodium, aclonifen, bifenox, chlornitrofen, difenoxuron, ethoxyfen, fluorodifen, fluoroglycofen-ethyl, fomesafen, furyloxyfen, lactofen, nitrofen, nitrofluorfen, oxyfluorfen;
dipyridyls, such as cyperquat, difenzoquat methylsulfate, diquat, paraquat dichloride;
imidazoles, such as isocarbamid;
imidazolinones, such as imazamethapyr, imazapyr, imazaquin, imazamethabenz-methyl, imazethapyr, imazapic, imazamox;
oxadiazoles, such as methazole, oxadiargyl, oxadiazone;
oxiranes, such as tridiphane;
phenols, such as bromoxynil, ioxynil;
phenoxyphenoxypropionates, such as clodinafop, cyhalofop-butyl, diclofop-methyl, fenoxaprop-ethyl, fenoxaprop-P-ethyl, fenthiaprop-ethyl, fluazifop-butyl, fluazifop-P-butyl, haloxyfop-ethoxyethyl, haloxyfop-methyl, haloxyfop-P-methyl, isoxapyrifop, propaquizafop, quizalofop-ethyl, quizalofop-P-ethyl, quizalofop-tefuryl;
phenylacetic acids, such as chlorfenac;
phenylpropionic acids, such as chlorfenprop-methyl;
ppi active compounds, such as benzofenap, flumiclorac-pentyl, flumioxazin, flumipropyn, flupropacil, pyrazoxyfen, sulfentrazone, thidiazimin;
pyrazoles, such as nipyraclofen;
pyridazines, such as chloridazon, maleic hydrazide, norflurazon, pyridate;
pyridinecarboxylic acids, such as clopyralid, dithiopyr, picloram, thiazopyr;
pyrimidyl ethers, such as pyrithiobac acid, pyrithiobac-sodium, KIH-2023, KIH-6127;
sulfonamides, such as flumetsulam, metosulam;
triazolecarboxamides, such as triazofenamide;
uracils, such as bromacil, lenacil, terbacil;
furthermore benazolin, benfuresate, bensulide, benzofluor, bentazon, butamifos, cafenstrole, chlorthal-dimethyl, cinmethylin, dichlobenil, endothall, 5-fluoro-2-phenyl-4H-3,1-benzoxazin-4-one (fluorbentranil), mefluidide, perfluidone, piperophos, topramezone and prohexadione-calcium;
sulfonylureas, such as amidosulfuron, azimsulfuron, bensulfuron-methyl, chlorimuron-ethyl, chlorsulfuron, cinosulfuron, cyclosulfamuron, ethametsulfuron-methyl, flazasulfuron, halosulfuron-methyl, imazosulfuron, metsulfuron-methyl, nicosulfuron, primisulfuron, prosulfuron, pyrazosulfuron-ethyl, rimsulfuron, sulfometuron-methyl, thifensulfuron-methyl, triasulfuron, tribenuron-methyl, triflusulfuron-methyl, tritosulfuron;
plant protection active compounds of the cyclohexenone type, such as alloxydim, clethodim, cloproxydim, cycloxydim, sethoxydim and tralkoxydim. Very particularly preferred herbicidal active compounds of the cyclohexenone type are: tepraloxydim (cf. AGROW, No. 243, 11.3.95, page 21, caloxydim) and
2-(1-[2-{4-chlorophenoxy}propyloxyimino]butyl)-3-hydroxy-5-(2H-tetrahydrothiopyran-3-yl)-2-cyclohexen-1-one, and of the sulfonylurea type: N-(((4-methoxy-6-[trifluoromethyl]-1,3,5-triazin-2-yl)amino)carbonyl)-2-(trifluoro-methyl)benzenesulfonamide.

Examples of insecticides which can be formulated using the homo- or copolymers P according to the invention comprise:
organo(thio)phosphates, such as acephate, azamethiphos, azinphos-ethyl, azinphos-methyl, cadusafos, chlorethoxyfos, chlorfenvinphos, chlormephos, chlorpyrifos, chlorpyrifos-methyl, coumaphos, cyanophos, demeton-S-methyl, diazinon, dichlorvos/DDVP, dicrotophos, dimethoate, dimethylvinphos, disulfoton, EPN, ethion, ethoprophos, famphur, fenamiphos, fenitrothion, fenthion, fosthiazate, heptenophos, isoxathion, malathion, mecarbam, methamidophos, methidathion, parathion-methyl, mevinphos, monocrotophos, naled, omethoate, oxydemeton-methyl, paraoxon, parathion, parathion-methyl, phenthoate, phorate, phosalone, phosmet, phosphamidon, phoxim, pirimiphos-ethyl, pirimiphos-methyl, profenofos, propetamphos, prothiofos, pyraclofos, pyridaphenthion, quinalphos, sulfotep, sulprofos, tebupirimfos, temephos, terbufos, tetrachlorvinphos, thiometon, triazophos, trichlorfon, vamidothion;
carbamates, such as alanycarb, aldicarb, bendiocarb, benfuracarb, butocarboxim, butoxycarboxim, carbaryl, carbofuran, carbosulfan, ethiofencarb, fenobucarb, fenoxycarb, formethanate, furathiocarb, isoprocarb, methiocarb, methomyl, metolcarb, oxamyl, pirimicarb, propoxur, thiodicarb, thiofanox, triazamate, trimethacarb, XMC, xylylcarb;
pyrethroids, such as acrinathrin, allethrin, d-cis-trans-allethrin, d-trans-allethrin, bifenthrin, bioallethrin, bioallethrin S-cyclopentenyl, bioresmethrin, cycloprothrin, cyfluthrin, beta-cyfluthrin, cyhalothrin, lambda-cyhalothrin, gamma-cyhalothrin, cyphenothrin, cypermethrin, alpha-cypermethrin, beta-cypermethrin, theta-cypermethrin, zeta-cypermethrin, deltamethrin, empenthrin, esfenvalerate, etofenprox, fenpropathrin, fenvalerate, flucythrinate, flumethrin, tau-fluvalinate, halfenprox, imiprothrin, permethrin, phenothrin, prallethrin, profluthrin, pyrethrin I and II, resmethrin, RU 15525, silafluofen, tau-fluvalinate, tefluthrin, tetramethrin, tralomethrin, transfluthrin, dimefluthrin, ZXI 8901;
arthropodal growth regulators: a) chitin synthesis inhibitors, e.g. benzoylureas, such as bistrifluoron, chlorfluazuron, diflubenzuron, flucycloxuron, flufenoxuron, hexaflumuron, lufenuron, novaluron, noviflumuron, teflubenzuron, triflumuron, buprofezin, diofenolan, hexythiazox, etoxazole, clofentezine; b) ecdysone antagonists, such as chromafenozide, halofenozide, methoxyfenozide, tebufenozide, azadirachtin; c) juvenile hormone mimetics, such as pyriproxyfen, hydroprene, kinoprene, methoprene, fenoxycarb; d) lipid biosynthesis inhibitors, such as spirodiclofen, spiromesifen, spirotetramat;
nicotine receptor agonists/antagonists: acetamiprid, clothianidin, dinotefuran, imidacloprid, nitenpyram, thiacloprid, thiamethoxam, nicotine, bensultap, cartap hydrochloride, thiocyclam, thiosultap-sodium and AKD1022;
GABA antagonists, such as acetoprole, chlordane, endosulfan, ethiprole, gamma-HCH (lindane), fipronil, vaniliprole, pyrafluprole, pyriprole, phenylpyrazole compounds of the formula ┌¹

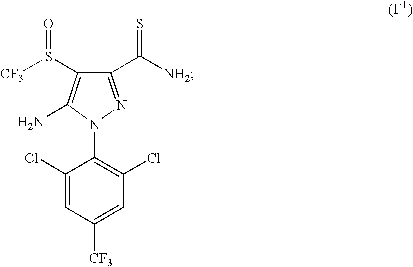

macrocyclic lactones, such as abamectin, emamectin, emamectin benzoate, milbemectin, lepimectin, spinosad;
METI I compounds, such as fenazaquin, fenpyroximate, flufenerim, pyridaben, pyrimidifen, rotenone, tebufenpyrad, tolfenpyrad;
METI II and III compounds, such as acequinocyl, fluacypyrim, hydramethylnon;
uncoupling compounds, such as chlorfenapyr, DNOC;
inhibitors of oxidative phosphorylation, such as azocyclotin, cyhexatin, diafenthiuron, fenbutatin oxide, propargite, tetradifon;
molting inhibitors: cyromazine, chromafenozide, halofenozide, methoxy-fenozide, tebufenozide;
synergists, such as piperonyl butoxide and tribufos;
sodium channel blockers, such as indoxacarb, metaflumizone;
selective inhibitors of food intake: cryolite, pymetrozine, flonicamid;
mite growth inhibitors: clofentezine, hexythiazox, etoxazole;
chitin synthesis inhibitors, such as buprofezin, bistrifluoron, chlorfluazuron, diflubenzuron, flucycloxuron, flufenoxuron, hexaflumuron, lufenuron, novaluron, noviflumuron, teflubenzuron, triflumuron;
lipid biosynthesis inhibitors, such as spirodiclofen, spiromesifen, spirotetramat;
octopaminergic agonists, such as amitraz;
ryanodine receptor modulators, such as flubendiamide;
various: amidoflumet, benclothiaz, benzoximate, bifenazate, bromopropylate, cyenopyrafen, cyflumetofen, quinomethionate, dicofol, fluoroacetate, pyridalyl, pyrifluquinazon, N—R′-2,2-dihalo-1-R″-cyclopropanecarboxamide 2-(2,6-dichloro-α, α,α-trifluoro-p-tolyl)hydrazone, N—R′-2,2-di(R″′)propionamide 2-(2,6-dichloro-α,α,α-trifluoro-p-tolyl)hydrazone, in which R′ is methyl or ethyl, halo is chlorine or bromine, R″ is hydrogen or methyl and R″′ is methyl or ethyl;
anthranilamides, such as chloranthraniliprole, and the compound of the formula ┌²

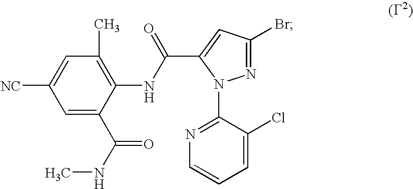

malononitrile compounds, such as CF₃(CH₂)₂C(CN)₂CH₂(CF₂)₃CF₂H, CF₃(CH₂)₂C(CN)₂CH₂(CF₂)₅CF₂H, CF₃(CH₂)₂C(CN)₂(CH₂)₂C(CF₃)₂F, CF₃(CH₂)₂C(CN)₂(CH₂)₂(CF₂)₃CF₃, CF₂H(CF₂)₃CH₂C(CN)₂CH₂(CF₂)₃CF₂H, CF₃(CH₂)₂C(CN)₂CH₂(CF₂)₃CF₃, CF₃(CF₂)₂CH₂C(CN)₂CH₂(CF₂)₃CF₂H, CF₃CF₂CH₂C(CN)₂CH₂(CF₂)₃CF₂H, 2-(2,2,3,3,4,4,5,5-octafluoropentyl)-2-(3,3,4,4,4-pentafluorobutyl)malonodinitrile and CF₂HCF₂CF₂CF₂CH₂C(CN)₂CH₂CH₂CF₂CF₃;
pyrimidinyl alkynyl ethers of the formula Γ³ or thiadiazolyl alkynyl ethers of the formula Γ⁴:

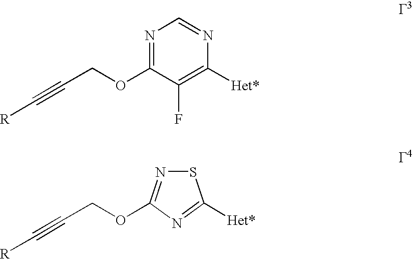

in which R is methyl or ethyl and Het* is 3,3-dimethylpyrrolidin-1-yl, 3-methyl-piperidin-1-yl, 3,5-dimethylpiperidin-1-yl, 4-methylpiperidin-1-yl, hexahydroazepin-1-yl, 2,6-dimethylhexahydroazepin-1-yl or 2,6-dimethyl-morpholin-4-yl. These compounds are described, for example, in JP 2006 131529.

A preferred embodiment of the invention relates to the use of the homo- or copolymers P according to the invention for the preparation of active compound formulations of fungicides which are insoluble or sparingly soluble in water or to the use of the homo- or copolymers P according to the invention for the solubilization in an aqueous medium of fungicides which are insoluble or sparingly soluble in water.

In a preferred embodiment, the active compound is chosen from
strobilurins, e.g. azoxystrobin, dimoxystrobin, fluoxastrobin, kresoxim-methyl, metominostrobin, orysastrobin, picoxystrobin, pyraclostrobin and trifloxystrobin, in particular pyraclostrobin,
conazole fungicides, in particular prochloraz, cyproconazole, epoxiconazole, fluquinconazole, hexaconazole, metconazole, penconazole, propiconazole, prothioconazole, tebuconazole and triticonazole, and especially epoxiconazole, metconazole, fluquinconazole or prothioconazole,
6-aryl-[1,2,4]triazolo-[1,5-a]pyrimidines, e.g 5-chloro-7-(4-methylpiperidin-1-yl)-6-(2,4,6-trifluorophenyl)-[1,2,4]triazolo[1,5-a]pyrimidine,
carboxamides, in particular carboxanilides, such as, e.g., benalaxyl, benodanil, bixafen, boscalid, carboxin, mepronil, fenfuram, fenhexamide, flutolanil, furametpyr, metalaxyl, ofurace, oxadixyl, oxycarboxin, penthiopyrad, thifluzamide, tiadinil, N-(4′-bromobiphenyl-2-yl)-4-difluoromethyl-2-methylthiazole-5-carboxamide, N-(4′-(trifluoromethyl)biphenyl-2-yl)-4-difluoromethyl-2-methyl-thiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoro-methyl-1-methylpyrazole-4-carboxamide, N-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide, N-(3′,4′-dichloro-5-fluorobiphenyl-2-yl)-3-difluoromethyl-1-methylpyrazole-4-carboxamide, N-(2-cyanophenyl)-3,4-dichloroisothiazole-5-carboxamide, N-(3′,4′,5′-trifluorobiphenyl-2-yl)-3-difluoro-methyl-1-methyl-1H-pyrazole-4-carboxamide, N-[2-(4′-trifluoromethylthio)-biphenyl]-3-difluoromethyl-1-methyl-1H-pyrazole-4-carboxamide, N-[2-(1,3-dimethylbutyl)phenyl]-1,3-dimethyl-5-fluoro-1H-pyrazole-4-carboxamide, N-[2-(bicyclopropyl-2-yl)phenyl]-3-difluoromethyl-1-methyl-1H-pyrazole-4-carboxamide, N-[2-(cis-2-bicyclopropyl-2-yl)phenyl]-3-difluoromethyl-1-methyl-1H-pyrazole-4-carboxamide, N-[2-(trans-2-bicyclopropyl-2-yl)phenyl]-3-difluoro-methyl-1-methyl-1H-pyrazole-4-carboxamide, N-[1,2,3,4-tetrahydro-9-(1-methyl-ethyl)-1,4-methanonaphth-5-yl]-3-difluoromethyl-1-methyl-1H-pyrazole-4-carboxamide and also ethaboxam and penthiopyrad; and
mixtures of these active compounds.

In an additional embodiment of the active compound formulations according to the invention, these comprise a combination of at least two active compounds, in particular at least two fungicides. Specifically, the active compound combination is a combination of at least one conazole fungicide, especially epoxiconazole or metconazole, with at least one strobilurin, in particular pyraclostrobin, and, if appropriate, an additional active compound, e.g. fenpropidin; a combination of at least one conazole fungicide, especially epoxiconazole or metconazole, with at least one carboxamide, in particular one carboxanilide, especially boscalid, N-(4′-bromobiphenyl-2-yl)-4-difluoromethyl-2-methylthiazole-5-carboxamide, N-(4′-(trifluoromethyl)biphenyl-2-yl)-4-difluoromethyl-2-methylthiazole-5-carboxamide, N-(4′-chloro-3′-fluorobiphenyl-2-yl)-4-difluoromethyl-2-methylthiazole-5-carboxamide, N-(3′,4′-dichloro-4-fluorobiphenyl-2-yl)-3-difluoromethyl-1-methylpyrazole-4-carboxamide, N-(3′,4′-dichloro-5-fluorobiphenyl-2-yl)-3-difluoro-methyl-1-methylpyrazole-4-carboxamide, N-(2-cyanophenyl)-3,4-dichloroisothiazole-5-carboxamide, N-(3′,4′,5′-trifluorobiphenyl-2-yl)-3-difluoromethyl-1-methyl-1H-pyrazole-4-carboxamide, N-[2-(4′-trifluoromethylthio)biphenyl]-3-difluoromethyl-1-methyl-1H-pyrazole-4-carboxamide, N-[2-(1,3-dimethylbutyl)phenyl]-1,3-dimethyl-5-fluoro-1H-pyrazole-4-carboxamide, N-[2-(bicyclopropyl-2-yl)phenyl]-3-difluoromethyl-1-methyl-1H-pyrazole-4-carboxamide, N-[2-(cis-2-bicyclopropyl-2-yl)phenyl]-3-difluoromethyl-1-methyl-1H-pyrazole-4-carboxamide, N-[2-(trans-2-bicyclopropyl-2-yl)phenyl]-3-difluoro-methyl-1-methyl-1H-pyrazole-4-carboxamide or N-[1,2,3,4-tetrahydro-9-(1-methylethyl)-1,4-methanonaphth-5-yl]-3-difluoromethyl-1-methyl-1H-pyrazole-4-carboxamide, and, if appropriate, an additional active compound, e.g. fenpropidin; a combination of two different conazole fungicides, especially epoxiconazole, with at least one additional conazole fungicide other than epoxiconazole, in particular with a conazole fungicide chosen from prochloraz, cyproconazole, fluquinconazole, hexaconazole, metconazole, penconazole, propiconazole, prothioconazole, tebuconazole and triticonazole and especially metconazole, fluquinconazole and prothioconazole; and a combination of at least one 6-aryl-[1,2,4]triazolo[1,5-a]pyrimidine, especially 5-chloro-7-(4-methyl-piperidin-1-yl)-6-(2,4,6-trifluorophenyl)-[1,2,4]triazolo[1,5-a]pyrimidine, with at least one other fungicidal active compound, especially with one or more conazole fungicides.

An additional preferred embodiment of the invention relates to the use of the homo- and copolymers P according to the invention for the stabilization of aqueous compositions comprising at least one insecticidal active compound which is chosen in particular from arylpyrroles such as chlorfenapyr, pyrethroids, such as bifenthrin, cyfluthrin, cycloprothrin, cypermethrin, deltamethrin, esfenvalerate, ethofenprox, fenpropathrin, fenvalerate, cyhalothrin, lambda-cyhalothrin, permethrin, silafluofen, tau-fluvalinate, tefluthrin, tralomethrin, alpha-cypermethrin and zeta-cypermethrin and permethrin, neonicotinoids and semicarbazones, such as metaflumizone.

A preferred embodiment of the invention accordingly also relates to the use of the homo- and copolymers P for the stabilization of insecticides, in particular of arylpyrroles, of pyrethroids, of neonicotinoids and of metaflumizone, in an aqueous phase.

In addition, the homo- and copolymers P according to the invention are suitable for the stabilization of pharmaceutical active compounds in aqueous active compound compositions. Examples of pharmaceutical active compounds are benzodiazepines, antihypertensives, vitamins, cytostatics, in particular taxol, anesthetics, neuroleptics, antidepressants, antibiotics, antimycotics, chemotherapeutics, urologics, thrombocyte aggregation inhibitors, sulfonamides, spasmolytics, hormones, immunoglobulins, sera, thyroid therapeutic agents, psychopharmacological agents, antiparkinsonians and other antihyperkinetic agents, ophthalmics, neuropathy preparations, calcium metabolism regulators, muscle relaxants, narcotics, antilipemics, hepatic therapeutic agents, coronary agents, cardiacs, immunotherapeutics, regulatory peptides and their inhibitors, hypnotics, sedatives, gynecological agents, antigouts, fibrinolytic agents, enzyme preparations and transport proteins, enzyme inhibitors, emetics, circulation-promoting agents, diuretics, diagnostics, corticoids, cholinergics, bile duct therapeutics, antiasthmatics, broncholytics, beta-receptor blockers, calcium antagonists, ACE inhibitors, arteriosclerotics, antiinflammatories, anticoagulants, antihypotonics, antihypoglycemics, antihypertonics, antifibrinolytics, antiepileptics, antiemetics, antidotes, antidiabetics, antiarrhythmics, antianemics, antiallergics, anthelmintics, analgesics, analeptics, aldosterone antagonists and slimming agents. Examples of suitable pharmaceutical active compounds are in particular the active compounds mentioned in paragraphs 0105 to 0131 of US 2003/0157170.

Another subject matter of the invention is active compound compositions, in particular active compound formulations, comprising at least one active compound which is sparingly soluble in water, at least one surface-active substance and at least one homo- or copolymer P. The compositions can be formulations, i.e. compositions, comprising the active compound in concentrated form or aqueous ready-for-use compositions comprising the active compound in a diluted form.

Examples of formulations according to the invention comprising at least one homo- or copolymer P are:
aqueous formulations in which the active compound is present in suspended or dispersed form (SC formulations);
water-dilutable emulsifiable concentrates (EC formulations) in which the active compound is present dissolved in a water-immiscible solvent, for example a hydrocarbon or a vegetable oil or vegetable oil derivative, such as a vegetable oil methyl ester;
water-dilutable oil-based suspension concentrates (OD formulations) in which the active compound is present dispersed or suspended in a water-immiscible solvent, for example a hydrocarbon or a vegetable oil or vegetable oil derivative, such as a vegetable oil methyl ester;
water-dilutable concentrates in which the active compound is present dissolved in a water-miscible solvent, for example a lactam, such as N-methylpyrrolidone or N-ethylpyrrolidone, a lactone, such as butyrolactone, a cyclic carbonate, such as ethylene or propylene carbonate, a cyclic ether, such as tetrahydrofuran or dioxane, or an alkanol or alkanediol, such as ethanol, propanol, isopropanol, ethylene glycol, diethylene glycol, propylene glycol or butanediol, or in a mixture of the abovementioned water-miscible solvents (DC formulations). The term “a water-miscible solvent” is understood to mean an organic solvent which dissolves completely to at least 100 g/l in water at 25° C. and which in particular does not exhibit any miscibility gap with water at this temperature;
solid formulations, such as powders or granules, which can be diluted with water and which typically comprise a solid carrier.

In the active compound formulations according to the invention, the total concentration of active compound(s) typically lies in the range from 0.1 to 80% by weight, frequently in the range from 0.5 to 70% by weight, in particular in the range from 0.5 to 60% by weight and especially in the range from 1 to 50% by weight or from 1 to 40% by weight or from 2 to 30% by weight, based on the total weight of the formulation. The concentration of surface-active substances in the formulations typically lies in the range from 1 to 50% by weight, in particular in the range from 1 to 45% by weight and especially in the range from 1 to 40% by weight, based on the total weight of the active compound formulation. The active compound formulations according to the invention comprise the at least one homo- or copolymers P usually in an amount of at least 1% by weight, preferably of at least 5% by weight, e.g. in an amount of 5 to 2000% by weight, frequently of 10 to 1000% by weight, in particular of 10 to 500% by weight or of 10 to 300% by weight or of 10 to 100% by weight, especially in an amount of 10 to 60% by weight, based on the active compound(s). In the active compound formulations, the concentration of the homo- or copolymers P typically lies in the range from 0.01 to 15% by weight, in particular in the range from 0.1 to 10% by weight and especially in the range from 0.5 to 6% by weight, based on the total weight of the formulation.

Aqueous formulations are preferred formulations. In aqueous active compound formulations, the total concentration of active compound(s) typically lies in the range from 0.1 to 80% by weight, frequently in the range from 0.5 to 70% by weight, in particular in the range from 0.5 to 60% by weight and especially in the range from 1 to 50% by weight or in the range from 1 to 40% by weight or from 2 to 30% by weight, based on the total weight of the aqueous composition. The concentration of surface-active substances in the aqueous formulations typically lies in the range from 1 to 50% by weight, in particular in the range from 1 to 45% by weight and especially in the range from 1 to 40% by weight, based on the total weight of the active compound formulation. In the aqueous active compound formulations, the concentration of the homo- or copolymers P typically lies in the range from 0.01 to 15% by weight, in particular in the range from 0.1 to 10% by weight and especially in the range from 0.5 to 6% by weight, based on the total weight of the formulation.

In addition to the abovementioned constituents, the aqueous active compound composition comprises water as diluent. In addition to water, the composition can also comprise one or more organic water-miscible solvents. The proportion of the solvents will generally not exceed 10% by weight, based on the weight of the composition.

In the aqueous compositions according to the invention, the water or the mixture of water with the water-miscible organic solvent forms a continuous phase comprising the active compound as a disperse phase. The active or effect compound and the surface-active substance are presumably present in these aqueous active compound formulations in the form of aggregates (e.g. micelles) of active compound and surface-active substance. This phase, which comprises the active compound, consequently forms a disperse phase comprising the active compound or the effect compound and the surface-active substance. The homo- and copolymers P present according to the invention stabilize this disperse phase and effectively prevent separation of the active compound, such as, for example, can occur by crystallization of the active compound.

In the aqueous formulations according to the invention, the active compound is present in suspended form since it is sparingly soluble in water. According to the type of the preparation, the mean particle size of the active compound particles (volume-average, determined by light scattering) typically lies in the range from 10 nm to 5 μm, frequently in the range from 20 nm to 3 μm and in particular in the range from 100 nm to 2 μm. Preferably, the d₉₀ value, i.e. that diameter which more than 90% by volume of the particles fall below, will not exceed a value of 10 μm, in particular 5 μm. For methods for the determination of the particle size in dispersions using dynamic or quasielastic light scattering, see, e.g., H. Wiese in D. Distler, Wässrige Polymerdispersionen [Aqueous Polymer Dispersions], Wiley-VCH 1999, chapter 4.2.1, pp. 40ff, and the literature cited therein, and also H. Auweter and D. Horn, J. Colloid Interf. Sci., 105 (1985), 399, D. Lilge and D. Horn, Colloid Polym. Sci., 269 (1991), 704, or H. Wiese and D. Horn, J. Chem. Phys., 94 (1991), 6429, and W. Brown, Dynamic Light Scattering, Oxford University Press, 1992.

Another subject matter of the invention is aqueous active compound preparations comprising the active compound in diluted form. These active compound preparations can be obtained by diluting an active compound formulation with water, the diluting taking place according to the invention in the presence of the homo- or copolymer P. In this connection, the homo- or copolymer can be present partially or completely in the formulation intended for diluting or it can be added on diluting with water. According to a preferred embodiment, the formulation to be diluted comprises the at least one homo- or copolymer P. In another embodiment, the water used for the diluting comprises the at least one homo- or copolymer.

Correspondingly, the active compound composition which can be obtained by diluting with water also comprises, in addition to the active compound and the at least one surface-active substance, the at least one homo- or copolymer P.

In the aqueous active compound preparations which can be obtained by diluting, the homo- or copolymer P is generally used in an amount of 0.05 to 20 parts by weight, preferably in an amount of 0.1 to 10 parts by weight, based on 1 part by weight of the active compound. Generally, the active compound preparations which can be obtained by diluting with water comprise the polymer P in an amount of 0.01 to 5% by weight, in particular of 0.1 to 3% by weight, based on the total weight of the active compound preparation.

The amount of the water used for the diluting depends in a way known per se on the concentration of the active compound desired for the application. Typically, use is made, for the diluting, of at least 10 parts by volume, frequently at least 20 parts by volume, in particular at least 50 parts by volume, e.g. from 10 to 10 000 parts by volume, in particular from 20 to 5000 parts by volume and especially from 50 to 4000 parts by volume, of water or of an aqueous solution of the polymer P, based on 1 part by volume of the formulation.

On diluting the formulation with water in the presence of the homo- or copolymer P, an aqueous suspension or emulsion of the active compound in an aqueous phase is obtained. According to the type of the formulation used, the mean particle size of the active compound particles (volume-average, determined by light scattering) typically lies in the range from 10 nm to 5 μm, frequently in the range from 50 nm to 3 μm and in particular in the range from 100 nm to 2 μm. Preferably, the d₉₀ value, i.e. that diameter which more than 90% by volume of the particles fall below, will not exceed a value of 10 μm, in particular 5 μm.

On diluting with water, the aqueous active compound composition, provided that it comprises a solubilizing polymer, furnishes a dilute aqueous composition in which the active compound is present in an extremely fine, i.e. nanodisperse, distribution in the aqueous phase. If the active compound composition comprises a solubilizing polymer, in particular one of the abovementioned block copolymers, the apparent particle size of the active compound particles is clearly less than 1000 nm and is in many cases not more than 500 nm, frequently not more than 400 nm, in particular not more than 300 nm, particularly preferably not more than 250 nm and very particularly preferably not more than 200 nm, and lies, e.g., in the range from 5 to 400 nm, frequently in the range from 10 to 300 nm, preferably in the range from 10 to 250 nm and in particular in the range from 20 to 200 nm. According to the type of the solubilizing polymer and of the active compound or effect compound and also depending on the concentration ratios, the aggregates can even become so small that they are no longer present in the form of detectable discrete particles (particle size <20 nm, <10 nm or <5 nm). The stabilizing effect also occurs, however, with aqueous dilutings in which the mean particle size (volume-average) lies above 1000 nm, e.g. in the range from 1 to 5 μm, frequently in the range from 1 to 3 μm and in particular in the range from 1 to 2 μm.

In addition, the active compound compositions (i.e., the formulations and the aqueous active compound preparations which can be obtained by diluting) can comprise conventional formulation auxiliaries in the amounts normal for this. These include, for example, rheology-modifying agents (thickeners), antifoam agents, bactericides, antifreeze agents, pH-regulating agents, and the like.

Suitable thickeners are compounds which bestow a pseudoplastic flow behavior on aqueous compositions, i.e. high viscosity at rest and low viscosity in the agitated state. Mention may be made, in this connection, for example, of polysaccharides, such as xanthan (Kelzan® from Kelco; Rhodopol® 23 from Rhône-Poulenc; or Veegum® from R.T. Vanderbilt), and also inorganic layered minerals, such as Attaclay® (Engelhardt), xanthan preferably being used.

Silicone emulsions (such as, e.g., Silikon® SRE, from Wacker, or Rhodorsil® from Rhodia), long-chain alcohols, fatty acids, fluoroorganic compounds and the mixtures thereof, for example, are suitable as antifoam agents for the compositions according to the invention.

Bactericides can be added for the stabilization to the compositions according to the invention against infection by microorganisms. In this connection, they are typically isothiazolinone or isothiazolone compounds, e.g. 1,2-benzisothiazolin-3-one, 5-chloro-2-methylisothiazol-3-one, 2-methylisothiazol-3-one or 2-octylisothiazol-3-one, which can be obtained, for example, under the tradenames Proxel® from Arch Chemical Inc., Acticide® RS from Thor Chemie and Kathon® MK from Rohm & Haas.

Suitable antifreeze agents are organic polyols, e.g. ethylene glycol, propylene glycol or glycerol. These are used in aqueous formulations, usually in amounts of not more than 20% by weight, e.g. from 1 to 20% by weight and in particular from 2 to 10% by weight, based on the total weight of the aqueous active compound formulation.

If appropriate, the active compound formulations according to the invention can comprise from 1 to 5% by weight, based on the total amount of the formulation prepared, of agent for regulating the pH of the formulation or of the diluted application form, the amount and type of the agent used depending on the chemical properties and the amount of the active compounds and homo- or copolymer P. Examples of pH-regulating agents (buffers) are alkali metal salts of weak inorganic or organic acids, such as, e.g., phosphoric acid, boric acid, acetic acid, propionic acid, citric acid, fumaric acid, tartaric acid, oxalic acid and succinic acid.

The aqueous active compound compositions according to the invention can be prepared in a way known per se, and the preparation depends in a way known per se on the type of the formulation. Processes for this are known, for example from U.S. Pat. No. 3,060,084, EP-A 707 445, Browning, “Agglomeration”, Chemical Engineering, Dec. 4, 1967, 147-148, Perry's Chemical Engineer's Handbook, 4th ed., McGraw-Hill, New York, 1963, pp. 8-57, WO 91/13546, U.S. Pat. No. 4,172,714, U.S. Pat. No. 4,144,050, U.S. Pat. No. 3,920,442, U.S. Pat. No. 5,180,587, U.S. Pat. No. 5,232,701, U.S. Pat. No. 5,208,030, GB 2 095 558, U.S. Pat. No. 3,299,566, Klingman, “Weed Control as a Science”, John Wiley and Sons, New York 1961, Hance et al. Weed Control Handbook, 8^{th} ed., Blackwell Scientific Publications, Oxford, 1989, H. Mollet et al., “Formulation Technology”, Wiley VCH-Verlag, Weinheim, 2001, and also the processes described in WO 2005/121201 and WO 2006/084680. According to a first preferred embodiment, the aqueous active compound compositions according to the invention are prepared by suspending at least one surface-active substance, the at least one active compound and also, if appropriate, a portion or the total amount of the conventional auxiliaries and, if appropriate, the homo- or copolymer in water and by subsequently reducing the active compound in size to the desired particle size by a milling process. The remaining amounts of auxiliaries, if desired, and the remaining amount of homo- or copolymer P, if not already added before the milling, can then be incorporated in the suspension thus obtained. In this connection, it has proven to be advantageous for at least a portion of the homo- or copolymer, preferably at least 50% by weight of the amount of polymer P provided in the formulation, to be already added before the milling. Suitable devices for the milling are ball mills, colloid mills and bead mills, generally one or more milling operations being carried out until the desired degree of size reduction is achieved.

According to another preferred embodiment, the aqueous active compound compositions according to the invention are prepared by introducing at least one surface-active substance, in particular a block copolymer, and the active compound or compounds into an organic solvent in which these are soluble. The solvent is suitably chosen so that it has a boiling point of <100° C. Subsequently, the solution is treated with water and the mixture is heated for long enough for the organic solvent to be essentially evaporated. Preferably, water is added to the mixture during the heating in order to replace coevaporated water. After cooling the aqueous active compound dispersion, this is finally treated with the homo- or copolymer P. In this connection, the polymer is suitably added in the form of an aqueous solution.

It is also possible to proceed in such a way that first a homogeneous mixture of at least one active compound, of at least one surface-active substance and of at least one homo- or copolymer is prepared and this mixture is introduced into water. Preferably, the homogeneous mixture is introduced into water in the form of a solution of the constituents in an organic solvent and the organic solvent is subsequently extensively or completely removed, e.g. by distillation, possible losses of water generally being compensated for. Suitable solvents for this are essentially those which are capable of dissolving both the active compound and the homo- or copolymer P, for example aliphatic nitriles, such as acetonitrile and propionitrile, N,N-dialkylamides of aliphatic carboxylic acids, such as dimethylformamide and dimethylacetamide, lactams and N-alkyllactams, such as N-methylpyrrolidone, N-ethylpyrrolidone or caprolactam, lactones, such as gamma-butyrolactone, carbonates, such as diethyl carbonate, ethylene carbonate or propylene carbonate, C₁-C₅-alkanols, such as methanol, ethanol, n-propanol, isopropanol, n-butanol, isobutanol or tert-butanol, aliphatic and alicyclic ethers, for example tetrahydrofuran or dioxane, halogenated hydrocarbons, such as dichloromethane or dichloroethane, esters of aliphatic C₁-C₄-carboxylic acids with C₁-C₆-alkanols, such as ethyl acetate, butyl acetate, butyl formate, methyl propionate, or methyl butyrate, and mixtures of the abovementioned solvents. Preferred organic solvents are in particular those which exhibit at least a limited miscibility with water, e.g. tetrahydrofuran, dioxane, C₁-C₅-alkanols, such as methanol, ethanol, n-propanol, isopropanol, n-butanol, isobutanol or tert-butanol, aliphatic nitriles, such as acetonitrile and propionitrile, N,N-dialkylamides of aliphatic carboxylic acids, such as dimethyl-formamide and dimethylacetamide, or N-alkyllactams, such as N-methylpyrrolidone. If appropriate, desired additives and auxiliaries can be incorporated in the composition at this point in a way known per se.

The aqueous active compound compositions according to the invention can alternatively be prepared by mixing a solution of the active compound in an organic solvent, which comprises a portion or the total amount of the surface-active substance and, if appropriate, a portion or the total amount of the homo- or copolymer P, with water or an aqueous solution, which comprises, if appropriate, the remaining amount of surface-active substance and, if appropriate, a portion or the total amount of the homo- or copolymer P, and subsequently removing the organic solvent. Mixing can be carried out in suitable stirred vessels, it being possible for both water or the aqueous solution of the homo- or copolymer P to be introduced and the solution of the active compound being added thereto or alternatively the solution of the active compound being introduced and the water or the aqueous solution of the homo- or copolymer P being added thereto. Subsequently, the organic solvent is completely or partially removed, e.g. by distillation, water being added, if appropriate.

In a preferred alternative form of this embodiment, the active compound solution and the water or the aqueous solution of the homo- or copolymer P are added continuously into a mixing region and the mixture is removed continuously from this, from which mixture the solvent is subsequently completely or partially removed. The mixing region can be organized in any way. In principle, all items of equipment which make possible continuous mixing of liquid streams are suitable for this. Such items of equipment are known, e.g. from Continuous Mixing of Fluids (J.-H. Henzler) in Ullmann's Encyclopedia, 5th ed. on CD-Rom, Wiley-VCH, and also from WO 2008/031780 and the literature cited therein. The mixing regions can be organized as static or dynamic mixers or hybrids thereof. In particular, Y-mixers, jet mixers or comparable mixers with nozzles are also suitable as mixing regions. In a preferred embodiment, the mixing region is the item of equipment or a comparable item of equipment described in the “Handbook of Industrial Crystallization” (A. S. Myerson, 1993, Butterworth-Heinemann, page 139, ISBN 0-7506-9155-7).

In addition, solid formulations can be prepared, for example, by mixing active compound, the at least one surface-active substance and the at least homo- or copolymer P, if appropriate together with a solid carrier and, if appropriate, additional auxiliaries, and milling in suitable way, e.g. using an airjet mill, to the desired fineness.

Surprisingly, it has also been shown that the homo- or copolymers P generally bring about an improvement in the stability of aqueous suspensions of active compounds which are sparingly soluble in water, without a conventional surface-active substance having to be present, such a surface-active substance however preferably being present. The homo- or copolymers P according to the invention act in this connection as dispersing agent or as protective colloid. Accordingly, an additional subject matter of the invention is the use of the homo- or copolymers P for the dispersing in aqueous compositions of organic active compounds which are sparingly soluble in water. For this, the homo- or copolymer P is generally used in an amount of 0.05 to 20 parts by weight, preferably in an amount of 0.1 to 10 parts by weight, in particular in an amount of 0.2 to 5 parts by weight, based on 1 part by weight of the active compound to be dispersed in the aqueous phase.

The active compound can be dispersed in water by milling an aqueous suspension of the at least one organic active compound which is sparingly soluble in water in an aqueous solution of the homo- or copolymer P as described above until the desired particle size is achieved. Alternatively, the active compound can be dispersed in water by mixing an aqueous solution of the homo- or copolymer P with a solution of the at least one active compound in an organic solvent, preferably in a water-miscible organic solvent, preferably with strong turbulence, and subsequently removing the organic solvent. In this way, aqueous active compound suspensions can be prepared, with or without additional surface-active substance. The active compound concentration in these suspensions typically lies in the range from 0.1 to 60% by weight, frequently in the range from 1 to 60% by weight, in particular in the range from 2 to 50% by weight, especially in the range from 3 to 40% by weight or 5 to 30% by weight, based on the total weight of the dispersion.

Depending on the type of the active compound or effect compound present, the active compound compositions according to the invention can be used in a way comparable per se to conventional formulations of the respective active or effect compound. For example, active compound formulations comprising at least one insecticidal, acaricidal or nematicidal active compound can be used for the combating of harmful arthropods, e.g. insects or acarids or nematodes. If the active compound formulations according to the invention comprise at least one fungicidal active compound, they can be used for the combating of harmful fungi. If the active compound formulations according to the invention comprise a herbicidal active compound, they can be used for the combating of grass weeds and the like.

Depending on the type of the active compound, the compositions according to the invention are used in particular for the protection of plants from attack by harmful organisms, such as insects, acarids or nematodes, or for protecting from infection by phytopathogenic fungi and the like, or in seed treatment or material protection, for example for the protection of lignocellulose materials, such as wood, from attack by harmful insects, such as wood-destroying beetles, termites, ants and the like, or from infection by wood-discoloring or wood-destroying fungi.

Of course, the compositions according to the invention can also be used in cosmetics or in medicine.

The following examples serve to illustrate the invention and are not to be understood as limiting.

### I. Preparation Examples:

### Preparation Example 1: Polymer P-1

200 g of isopropanol and 35 g of feed 1 were introduced into a reaction vessel with a stirrer, three separate feed inlets and a nitrogen inlet and the vessel was rendered inert with nitrogen. Subsequently, the vessel was heated to 75° C. and the remaining amount of feed 1 and feed 2 were added at this temperature at a constant feed rate, beginning at the same time, in 5 hours. After the end of the addition, the temperature was maintained for an additional hour and steam distillation was subsequently carried out in order to remove volatile monomers. In this way, an aqueous solution of the copolymer with a solids content of 14.8% by weight and a pH of 3.98 was obtained. The monomer composition and the K value of the polymer P-1 are given in table 1.
Feed 1: 400 g of isopropanol, 75 g of methyl methacrylate and 225 g of methacrylic acid
Feed 2: 50 g of isopropanol and 8 g of tert-butyl perpivalate

### Preparation Example 2: Polymer P-2

200 g of isopropanol were introduced into a reaction vessel with a stirrer, three separate feed inlets and a nitrogen inlet and the vessel was rendered inert with nitrogen. Subsequently, the vessel was heated to 75° C. and, beginning at the same time, with a constant rate of addition, feed 1 was added in 5.5 hours, feed 2 was added in 5 hours and feed 3 was added in 6 hours, at this temperature. After all the feeds had finished being run in, the mixture was left to polymerize for an additional one hour at 75° C. and then steam distillation of the polymerization mixture was carried out. In this way, a colorless viscous solution of the polymer P-2 in water with a pH of 4.1 and a solids content of 20.8% by weight was obtained.

The K value of the polymer P-2 and the monomer composition are given in table 1.

Feed 1: 250 g of isopropanol and 225 g of methacrylic acid
Feed 2: 75 g of methyl acrylate and 100 g of isopropanol
Feed 3: 100 g of isopropanol and 8 g of tert-butyl perpivalate

### Preparation Example 3: Polymer P-3

150 g of isopropanol and 11.65 g of feed 1 were introduced into a reaction vessel with a stirrer, three separate feed inlets and a nitrogen inlet and the vessel was rendered inert with nitrogen and then heated to 75° C. Then feed 1 was added in 5 hours and feed 2 was added in 5.5 hours, beginning at the same time, at 75° C., and the temperature was maintained for an additional hour after the feeds had finished being run in. Subsequently, feed 3 was added in 15 minutes at 75° C. and the temperature was maintained for 1.5 h. Subsequently, steam distillation was carried out. In this way, a slightly cloudy solution of the polymer P-3 with a solids content of 19.1% by weight was obtained. The K value is given in table 1.

Feed 1: 133 g of isopropanol and 100 g of methacrylic acid
Feed 2: 16.3 g of isopropanol and 2.7 g of tert-butyl perpivalate
Feed 3: 1.0 g of tert-butyl perneodecanoate and 20 g of isopropanol

### Preparation Example 4: Polymer P-4

The polymerization was carried out analogously to preparation example 3, feed 1 comprising 100 g of acrylic acid instead of 100 g of methacrylic acid. In this way, a cloudy solution of the polymer P-4 with a solids content of 34.8% by weight was obtained. The K value is given in table 1.

### Preparation Example 5: Polymer P-5

200 g of isopropanol, 15.25 g of feed 1 and 19.8 g of feed 2 were introduced into a reaction vessel with a stirrer, three separate feed inlets and a nitrogen inlet and the vessel was rendered inert with nitrogen and then heated to 75° C. Then the feeds 1 and 2 were added in 5 h and feed 3 was added in 5.5 h, beginning at the same time, while maintaining the temperature. After all the feeds had finished being run in, polymerization was allowed to take place for an additional hour, neutralization was carried out with 17 g of a 40% aqueous sodium hydroxide solution and then steam distillation was carried out. In this way, the polymer P-5 was obtained in the form of a clear, highly viscous, aqueous body with a solids content of 25.2% by weight and a pH of 4.4. The K value of the polymer P-5 is given in table 1.

Feed 1: 200 g of isopropanol and 105 g of methyl methacrylate
Feed 2: 200 g of isopropanol and 195 g of methacrylic acid
Feed 3: 50 g of isopropanol and 8 g of tert-butyl perpivalate

### Preparation Example 6: Polymer P-6

The polymerization was carried out analogously to the directions for preparation example 5, with the following differences:

The initial charge comprised 200 g of isopropanol, 13 g of feed 1 and 22.06 g of feed 2. Feed 1 comprised 200 g of isopropanol and 60 g of methyl methacrylate. Feed 2 comprised 200 g of isopropanol and 240 g of methacrylic acid. In this way, a clear highly viscous solution of the polymer P-6 with a solids content of 23.9% by weight was obtained. The K value is given in table 1.

### Preparation Example 7: Polymer P-7

The polymerization was carried out analogously to the directions for preparation example 5 with the following differences: the initial charge comprised 200 g of isopropanol, 10.75 g of feed 1 and 24.31 g of feed 2. Feed 1 comprised 200 g of isopropanol and 15 g of methyl methacrylate. Feed 2 comprised 200 g of isopropanol and 285 g of methacrylic acid. In this way, a clear, very viscous, aqueous solution of the polymer P-7 with a solids content of 21.8% by weight and a pH of 4.2 was obtained. The K value is given in table 1.

### Preparation Example 8: Polymer P-8

The polymerization was carried out analogously to the directions of preparation example 5 with the following differences: the initial charge comprised 200 g of isopropanol, 13.02 g of feed 1 and 22.06 g of feed 2. Feed 1 comprised 200 g of isopropanol, 60 g of methyl methacrylate and 0.3 g of mercaptoethanol. Feed 2 comprised 200 g of isopropanol and 240 g of methacrylic acid. In this way, a clear aqueous elastic body of the polymer P-8 with a solids content of 24.3% by weight and a pH of 4.3 was obtained. The K value is given in table 1.

### Preparation Example 9: Polymer P-9

The polymerization was carried out analogously to the directions of preparation example 5 with the following differences: the initial charge comprised 200 g of isopropanol, 13.23 g of feed 1 and 22.06 g of feed 2. Feed 1 comprised 200 g of isopropanol, 60 g of methyl methacrylate and 4.65 g of mercaptoethanol. Feed 2 comprised 200 g of isopropanol and 240 g of methacrylic acid. In this way, a clear viscous aqueous solution with a solids content of 25.5% by weight and a pH of 4.1 was obtained. The K value is given in table 1.

### Preparation Example 10: Polymer P-10

The polymerization was carried out analogously to the directions of preparation example 5 with the following differences: the initial charge comprised 200 g of isopropanol. Feed 1 comprised 225 g of methacrylic acid and 400 g of isopropanol. Feed 2 comprised 75 g of 2-hydroxypropyl acrylate and 100 g of isopropanol. In this way, a clear viscous solution of the polymer P-10 with a pH of 3.9 and a solids content of 29.4% by weight was obtained. The K value is given in table 1.

### Preparation Example 11: Polymer P-11

200 g of isopropanol were introduced into a reaction vessel with a stirrer, three separate feed inlets and a nitrogen inlet. Subsequently, the vessel was rendered inert with nitrogen and heated to 75° C. Then, feed 1 was added in 5.5 hours, feed 2 was added in 5 hours and feed 3 was added in 6 hours, beginning at the same time, with a constant rate of addition, while maintaining the temperature. After the feeds had finished being run in, the temperature was maintained for an additional hour and then steam distillation was carried out. In this way, a clear highly viscous solution of the polymer P-11 with a solids content of 25.4% by weight and a pH of 4.27 was obtained. The K value is given in table 1.

Feed 1: 250 g of isopropanol and 225 g of methacrylic acid
Feed 2: 75 g of N,N-dimethylacrylamide and 100 g of isopropanol
Feed 3: 100 g of isopropanol and 8 g of tert-butyl perpivalate.
Preparation example 12: Polymer P-12

300 g of toluene, 12 g of feed 1, 12 g of feed 2 and 3 g of feed 3 were introduced into a reaction vessel with a stirrer, three separate feed inlets and a nitrogen inlet. The vessel was rendered inert with nitrogen and heated to 90° C. Five minutes after reaching the temperature, the addition was carried out, while maintaining the temperature, beginning at the same time, of the feeds 1 and 2 in 3 h with a constant rate of addition and of feed 3 in 4.5 h, first half of feed 3 being metered in in 3 h and the remaining half of feed 3 being metered in in 1.5 h. After the feeds had finished being run in, polymerization was allowed to take place at 90° C. for a further 1.5 h. The precipitated product was filtered off by vacuum and washed with acetone, and dried at 75° C. and 100 mbar in a drying cabinet. In this way, a fine white powder was obtained. The K value is given in table 1.

### Preparation Example 13: Polymer P-13 (Comparison Polymer)

300 g of dimethylformamide (DMF) were heated to 95° C. Feed 1a, consisting of 600 g of DMF, 40.5 g of methyl methacrylate and 251.8 g of 2-acrylamido-2-methylpropane-sulfonic acid (AMPS), and feed 1b, consisting of 300 g of DMF, 1.9 g of azobisiso-butyronitrile (AIBN) and 5.8 g of mercaptoethanol, were added at the same time in 2 hours and the mixture was maintained at 95° C. for 24 hours. After 24 hours, no more methyl methacrylate was present (GC monitoring). Accordingly, the batch was cooled to ambient temperature and the solvent was subsequently removed under vacuum. The random copolymer, the number-average molecular weight of which was 6700 g/mol (determined by GPC in DMF), was obtained as a colorless solid.

### Preparation Example 14: Copolymer P-14

200 g of isopropanol and 40 g of feed 1 were introduced into a reaction vessel with a stirrer, five separate feed inlets and a nitrogen inlet and the vessel was rendered inert with nitrogen and then heated to 75° C. Then feed 1 was added in 5 hours and feed 2 was added in 5.5 hours, beginning at the same time, at 75° C., and the temperature was maintained for an additional hour after the feeds had finished being run in. 19.8 g of a 40% sodium hydroxide solution were then added to the reaction mixture. Subsequently, steam distillation was carried out. The reaction mixture was then allowed to cool down to ambient temperature and the addition was carried out, with stirring, of feed 3 in 5 minutes, then feed 4 in 15 minutes and, finally, feed 5 in 20 minutes. Stirring was subsequently allowed to take place at ambient temperature for a further 2 hours. In this way, a cloudy viscous solution of the copolymer P-14 with a solids content of 32.5% by weight was obtained. The K value is given in table 1.

Feed 1:

| | | |
|---|---|---|
| 450 | g | isopropanol, |
| 87.5 | g | methyl methacrylate and |
| 262.5 | g | methacrylic acid |

Feed 2:

| | | |
|---|---|---|
| 50 | g | isopropanol and |
| 9.3 | g | tert-butyl perpivalate |

Feed 3:

| | | |
|---|---|---|
| 5 | g | demineralized water and |
| 2.3 | g | hydrogen peroxide (30%) |

Feed 4:

| | | |
|---|---|---|
| 20 | g | demineralized water and |
| 0.46 | g | iron(II) sulfate |

Feed 5:

| | | |
|---|---|---|
| 20 | g | demineralized water and |
| 1.75 | g | L-(+)-ascorbic acid |

### Preparation Example 15: Copolymer P-15

600 g of isopropanol and 37.5 g of feed 1 were introduced into a reaction vessel with a stirrer, six separate feed inlets and a nitrogen inlet and the vessel was rendered inert with nitrogen and then heated to 75° C. Then the feeds 1 and 2 were added in 5 hours and feed 2 was added in 5.5 hours, beginning at the same time, at 75° C., and the temperature was maintained for an additional hour after the feeds had finished being run in. 17 g of a 40% sodium hydroxide solution were then added to the reaction mixture. Subsequently, steam distillation was carried out. The reaction mixture was then allowed to cool down to ambient temperature and the addition was carried out, with stirring, of feed 3 in 5 minutes, then feed 4 in 15 minutes and, finally, feed 5 in 20 minutes. Stirring was subsequently allowed to take place at ambient temperature for a further 2 hours. In this way, a milky white dispersion of the copolymer P-15 with a solids content of 20.6% by weight was obtained. The K value is given in table 1.

Feed 1:

| | | |
|---|---|---|
| 450 | g | isopropanol |
| 105 | g | methyl methacrylate and |
| 195 | g | methacrylic acid |

Feed 2:

| | | |
|---|---|---|
| 93 | g | isopropanol and |
| 8 | g | tert-butyl perpivalate |

Feed 3:

| | | |
|---|---|---|
| 5 | g | demineralized water and |
| 2 | g | hydrogen peroxide (30%) |

Feed 4

| | | |
|---|---|---|
| 20 | g | demineralized water and |
| 0.4 | g | iron(II) sulfate |

Feed 5:

| | | |
|---|---|---|
| 20 | g | demineralized water and |
| 1.5 | g | L-(+)-ascorbic acid |

### Preparation Example 16: Copolymer P-16

400 g of isopropanol and 62.03 g of feed 1 were introduced into a reaction vessel with a stirrer, five separate feed inlets and a nitrogen inlet and the vessel was rendered inert with nitrogen and then heated to 75° C. Then feed 1 was added in 5 hours and feed 2 was added in 5.5 hours, beginning at the same time, at 75° C., and the temperature was maintained for an additional hour after the feeds had finished being run in. 19.8 g of a 40% sodium hydroxide solution were then added to the reaction mixture. Subsequently, steam distillation was carried out. The reaction mixture was then allowed to cool down to ambient temperature and the addition was carried out, with stirring, of feed 3 in 5 minutes, then feed 4 in 15 minutes and, finally, feed 5 in 20 minutes. Stirring was subsequently allowed to take place at ambient temperature for a further 2 hours. In this way, a solution of the copolymer P-16 with a solids content of 20.1% by weight was obtained. The K value is given in table 1.

Feed 1:

| | | |
|---|---|---|
| 890.57 | g | isopropanol, |
| 210 | g | methacrylic acid, |
| 17.5 | g | styrene, |
| 35 | g | methyl methacrylate, |
| 70 | g | acrylic acid and |
| 17.5 | g | lauryl acrylate |

Feed 2:

| | | |
|---|---|---|
| 14 | g | tert-butyl perneodecanoate and |
| 100 | g | isopropanol |

Feed 3:

| | | |
|---|---|---|
| 5 | g | demineralized water and |
| 2.3 | g | hydrogen peroxide (30%) |

Feed 4:

| | | |
|---|---|---|
| 20 | g | demineralized water and |
| 0.46 | g | iron(II) sulfate |

Feed 5:

| | | |
|---|---|---|
| 20 | g | demineralized water and |
| 1.75 | g | L-(+)-ascorbic acid |

### Preparation Example 17: Copolymer P-17

180 g of isopropanol and 36 g of feed 1 were introduced into a reaction vessel with a stirrer, five separate feed inlets and a nitrogen inlet and the vessel was rendered inert with nitrogen and then heated to 75° C. Then feed 1 was added in 5 hours and feed 2 was added in 5.5 hours, beginning at the same time, at 75° C., and the temperature was maintained for an additional hour after the feeds had finished being run in. 19.8 g of a 40% sodium hydroxide solution were then added to the reaction mixture. Subsequently, steam distillation was carried out. The reaction mixture was then allowed to cool down to ambient temperature and the addition was carried out, with stirring, of feed 3 in 5 minutes, then feed 4 in 15 minutes and, finally, feed 5 in 20 minutes. Stirring was subsequently allowed to take place at ambient temperature for a further 2 hours. In this way, a cloudy viscous solution of the copolymer P-17 with a solids content of 32.6% by weight was obtained. The K value is given in table 1.

Feed 1:

| | | |
|---|---|---|
| 405 | g | isopropanol, |
| 204.75 | g | methacrylic acid, |
| 15.75 | g | styrene, |
| 31.5 | g | methyl methacrylate and |
| 63 | g | acrylic acid |

Feed 2:

| | | |
|---|---|---|
| 45 | g | isopropanol and |
| 12.55 | g | tert-butyl perpivalate |

Feed 3:

| | | |
|---|---|---|
| 4.5 | g | demineralized water and |
| 2.07 | g | hydrogen peroxide (30%) |

Feed 4:

| | | |
|---|---|---|
| 18 | g | demineralized water and |
| 0.41 | g | iron(II) sulfate |

Feed 5:

| | | |
|---|---|---|
| 18 | g | demineralized water and |
| 1.58 | g | L-(+)-ascorbic acid |

Reaction products obtained as a solid were suspended in water. Isopropanol was replaced by water in polymerization products obtained as a solution. Subsequently, just enough dilute sodium hydroxide solution was added to completely dissolve the polymer. In all cases, the degree of neutralization was less than 30%.

TABLE 1

| | Monomer M1 | | Monomer M2 | | |
|---|---|---|---|---|---|
| Polymer | Type²⁾ | Amount [pphm]³⁾ | Type²⁾ | Amount [pphm]³⁾ | K value¹⁾ |
| P-1 | MAA | 75 | MMA | 25 | 17.9 |
| P-2 | MAA | 75 | MA | 25 | 20.8* |
| P3 | MAA | 100 | — | 0 | 29.4 |
| P-4 | AA | 100 | — | 0 | 13.9 |
| P-5 | MAA | 65 | MMA | 35 | 18.0 |
| P-6 | MAA | 80 | MMA | 20 | 22.2 |
| P-7 | MAA | 95 | MMA | 5 | 27.2 |
| P-8 | MAA | 80 | MMA | 20 | 20.7 |
| P-9 | MAA | 80 | MMA | 20 | 15.8 |
| P-10 | MAA | 75 | HPA | 25 | n.d. |
| P-11 | MAA | 75 | DMAA | 25 | 14.7 |
| P-12 | MAA | 50 | VP | 50 | 12.9 |
| P-13⁴⁾ | AMPS | 86 | MMA | 14 | n.d. |
| P-14 | MAA | 75 | MMA | 25 | 32 |
| P-15 | MAA | 65 | MMA | 35 | 31 |
| P-16 | MAA + AA | 60 + 20⁵⁾ | MMA + LA + S | 10 + 5 + 5⁵⁾ | 25⁶⁾ |
| P-17 | MAA + AA | 65 + 20⁵⁾ | MMA + S | 10⁵⁾ | 21⁷⁾ |

¹⁾K value according to Fikentscher at 25° C., measured as 1% by weight solution in a 1:1 mixture of 0.1M aqueous sodium chloride solution with methanol at 25° C. (at pH 7).
²⁾MAA: methacrylic acid; AA: acrylic acid; MMA: methyl methacrylate; MA: methyl acrylate; HPA: hydroxypropyl acrylate; DMAA: N,N-dimethylacrylamide; VP: vinylpyrrolidone; AMPS: 2-acrylamido-2-methylpropanesulfonic acid
³⁾pphm: parts by weight per 100 parts by weight of the total monomer amount
⁴⁾Comparison polymer
⁵⁾pphm of the monomers in the sequence given
⁶⁾weight-average molecular weight M_{w}, determined by size exclusion chromatography: 30 400; polydispersity index M_{w}/Mₙ = 3.0 (Mₙ = number-average molecular weight)
⁷⁾weight-average molecular weight M_{w}, determined by size exclusion chromatography: 25 500; polydispersity index M_{w}/Mₙ = 2.9 (Mₙ = number-average molecular weight)
*1% in 0.1M aqueous sodium chloride solution, 25° C.
n.d. not determined

### Preparation Example 17 (Block Copolymer D1)

1445 g of tetrahydrofuran were heated at reflux. Feed 1a, consisting of 2109 g of methyl methacrylate and 703 g of styrene, and feed 1b, consisting of 1445 g of tetrahydrofuran, 18.6 g of azobisisobutyronitrile (AIBN) and 58.4 g of mercaptoethanol, were added at the same time in 2 hours and the mixture was maintained at reflux for 24 hours. 430 g of a commercial biuret of hexamethylene diisocyanate (NCO content of 22%, viscosity at 23° C. of 4.0 Pa·s), 2715 g of a methyl-terminated poly(ethylene oxide) (number-average molecular weight 2000 daltons, OH number 33 mg/g of solid matter) and 0.5 g of dibutyltin dilaurate were then added and the reaction mixture was stirred while maintaining the temperature for long enough for the NCO content to be 0%. 14 100 g of water were then added in 30 minutes and tetrahydrofuran was distilled off under reduced pressure. In this way, a 30% by weight aqueous dispersion of the amphiphilic polymer composition with a mean particle size of 47 nm (determined by dynamic light scattering) was obtained.

### Preparation Example 18 (Block Copolymer D2)

1445 g of tetrahydrofuran were heated at reflux. Feed 1a, consisting of 1817 g of methyl methacrylate, 735 g of styrene and 260 g of methacrylic acid, and feed 1b, consisting of 1445 g of tetrahydrofuran, 18.6 g of azobisisobutyronitrile (AIBN) and 58.4 g of mercaptoethanol, were added at the same time in 2 hours and the mixture was maintained at reflux for 24 hours. 430 g of a commercial biuret of hexamethylene diisocyanate (NCO content of 22%, viscosity at 23° C. of 4.0 Pa·s), 2715 g of a methyl-terminated poly(ethylene oxide) (number-average molecular weight 2000 daltons, OH number 33 mg/g of solid matter) and 0.5 g of dibutyltin dilaurate were then added and the reaction mixture was stirred while maintaining the temperature for long enough for the NCO content to be 0%. 14 100 g of water were then added in 30 minutes and tetrahydrofuran was distilled off under reduced pressure. In this way, a 30% by weight aqueous dispersion of the amphiphilic polymer composition with a mean particle size of 92 nm (determined by dynamic light scattering) was obtained.

### USE EXAMPLES

### Examples 1 to 25

General specification I for the preparation of a formulation comprising a solubilizing polymer:

60 g of 30% by weight solution of the block copolymer D1 or D2 in tetrahydrofuran, 11.67 g of a 30% by weight solution of pyraclostrobin in tetrahydrofuran and 12.5 g of a 20% by weight solution of epoxiconazole in tetrahydrofuran were introduced into a vessel and stirring was carried out until the mixture was homogeneous. 28 g of deionized water were added to this and the mixture was heated to 60 to 65° C., tetrahydrofuran being evaporated in from 2 to 3 hours. The amount of water was maintained at approximately 27±1.5 g by addition of water. The mixture was then cooled to ambient temperature and then 8.11 g of a 14.8% by weight solution of the polymer P in water were added with stirring. In this way, an aqueous formulation was obtained with the following composition:
30% by weight of the block copolymer D1 or D2
10% by weight of active compound (pyraclostrobin/epoxiconazole in the ratio by weight 7:5)
2% by weight of polymer P and
58% by weight of deionized water.

The respective formulation was examined every day for a week for the formation of crystals. Subsequently, observation was continued at an interval of one week for a total of 4 months. Crystallization sometimes started, in different forms. Either small amounts of precipitate were formed or the crystallization resulted in complete solidification of the formulation.

The results of this investigation are collated in table 2.

### Examples C26 to C31 and 32 to 40

### General Specification II for the Preparation of an Aqueous Formulation

The active compounds were dissolved in tetrahydrofuran (THF). The polymers P and surface-active substances were dissolved in water. The active compound solution and the polymer solution were subsequently mixed using a Y mixer analogously to example 1 of WO 2008/031780. Tetrahydrofuran was then removed under reduced pressure. 1% by weight, based on the total weight of the formulation, of block copolymer D1 from preparation example 17 was added to the active compound suspension obtained. The details (amount of active compound and solvent, concentrations of the polymer solutions and mixing ratios) are given in table 3.

For comparative purposes, formulations were prepared which comprised, instead of the polymers P, the following surface-active substances in the amounts given in table 3.
CP-1: Copolymer of 1-vinyl-2-pyrrolidone and vinyl acetate in a ratio by weight of 6:4 (Luvitec Va 64 from Basf Se)
CP-2: Cremophor® CO40 (PEG-40 hydrogenated castor oil; CAS No. 61788-85-0)

Aqueous formulations C26a to C31a and 32a to 40a were prepared analogously to examples C26 to C31 and 32 to 40, without the incorporation of a block copolymer. In this way, aqueous formulations were obtained which comprised the active compound in suspended form. Stabilities of the suspensions thus prepared corresponded each time to the stabilities observed in examples C26 to C31 and 32 to 40.

TABLE 2

| | | | Block | | Active compound | | | | | | |
|---|---|---|---|---|---|---|---|---|---|---|---|
| | Polymer P | | copolymer | | Epoxiconazole/ | | Addition of seed crystals¹⁾ | | | | |
| Ex. | | % by wt. | | % by wt. | Pyraclostrobin | % by wt. | Epoxiconazole | Pyraclostrobin | pH | Stability²⁾ | |
| C1³⁾ | — | 0 | D1 | 30 | (5:7) | 10 | − | − | x | ~1 | d |
| 2 | P-1 | 2 | D1 | 30 | (5:7) | 10 | − | − | 5.4 | 28 | d |
| 3 | P-1 | 6 | D1 | 30 | (5:7) | 10 | − | − | 5.4 | >4 | m |
| 4 | P-1 | 2 | D2 | 30 | (5:7) | 10 | − | − | 5.6 | >4 | m |
| 5 | P-1 | 6 | D2 | 30 | (5:7) | 10 | − | − | 5.3 | >4 | m |
| 6 | P-2 | 2 | D1 | 30 | (5:7) | 10 | − | − | 5.6 | 21 | d |
| 7 | P-3 | 2 | D1 | 30 | (5:7) | 10 | − | − | 4.0 | 35 | d |
| 8 | P-4 | 2 | D1 | 30 | (5:7) | 10 | − | − | 3.0 | >4 | m |
| 9 | P-5 | 2 | D1 | 30 | (5:7) | 10 | − | − | 6.1 | 42 | d |
| 10 | P-6 | 2 | D1 | 30 | (5:7) | 10 | − | − | 6.0 | >4 | m |
| 11 | P-7 | 2 | D1 | 30 | (5:7) | 10 | − | − | 5.9 | >4 | m |
| 12 | P-8 | 2 | D1 | 30 | (5:7) | 10 | − | − | 6.0 | >4 | m |
| 13 | P-9 | 2 | D1 | 30 | (5:7) | 10 | − | − | 5.8 | >4 | m |
| 14 | P-10 | 2 | D1 | 30 | (5:7) | 10 | − | − | 5.6 | 7 | d |
| 15 | P-11 | 2 | D1 | 30 | (5:7) | 10 | − | − | 4.0 | 8 | d |
| 16 | P-12 | 2 | D1 | 30 | (5:7) | 10 | − | − | 5.8 | 6 | d |
| C17 | P-13 | 2 | D1 | 30 | (5:7) | 10 | − | − | 2.0 | ~1 | d |
| 18 | P-1 | 2 | D2 | 30 | (5:7) | 10 | + | − | 5.4 | >4 | m |
| 19 | P-1 | 2 | D2 | 30 | (5:7) | 10 | − | + | 5.4 | >4 | m |
| 20 | P-3 | 2 | D1 | 30 | (5:7) | 10 | + | − | 4.0 | >34 | d |
| 21 | P-3 | 2 | D1 | 30 | (5:7) | 10 | − | + | 4.0 | >34 | d |
| 22 | P-4 | 2 | D1 | 30 | (5:7) | 10 | + | − | 3.0 | >4 | m |
| 23 | P-4 | 2 | D1 | 30 | (5:7) | 10 | − | + | 3.0 | >4 | m |
| 24 | P-1 | 2 | D2 | 30 | (7:5) | 10 | + | − | 5.4 | >4 | m |
| 25 | P-1 | 2 | D2 | 30 | (7:5) | 10 | − | + | 5.4 | >4 | m |

¹⁾+: yes; −: no
²⁾m.: month; d.: day
³⁾C: Comparison test

TABLE 3

| | | | | | | Stream 2: | | | |
|---|---|---|---|---|---|---|---|---|---|
| | Stream 1: Active compound solution | | | | | Aqueous polymer solution | | | |
| | Active compound [g] | | | | | Amount | | Concentration | |
| Example | Pyraclostrobin | Epoxiconazole | Boscalid | Metconazole | THF [g] | [g] | Polymer | [% by weight]¹⁾ | Stability |
| C26 | 35 | 25 | — | — | 100 | 1500 | CP-1 | 9.2 | ²⁾unstable |
| C27 | 35 | 25 | — | — | 100 | 1500 | CP-2 | 9.1 | ²⁾unstable |
| C28 | — | — | — | 70 | 100 | 1500 | — | 0 | ²⁾unstable |
| C29 | — | 20 | 10 | — | 100 | 1500 | — | 0 | ²⁾unstable |
| C30 | — | 20 | — | 10 | 100 | 1500 | — | 0 | ²⁾unstable |
| C31 | 35 | 25 | — | — | 100 | 1500 | — | 0 | ²⁾unstable |
| 32 | 35 | 25 | — | — | 100 | 1500 | P-14 | 8.4 | ³⁾stable |
| 33 | 70 | 50 | — | — | 200 | 1500 | P-14 | 9.2 | ³⁾stable |
| 34 | — | — | — | 14 | 86 | 1500 | P-14 | 9.1 | ³⁾stable |
| 35 | — | 20 | 10 | — | 70 | 900 | P-14 | 2.5 | ³⁾stable |
| 36 | 21 | 15 | — | — | 64 | 900 | P-14 | 2.5 | ³⁾stable |
| 37 | — | 20 | — | — | 80 | 1500 | P-14 | 2.5 | ³⁾stable |
| 38 | 35 | 25 | — | — | 100 | 1500 | P-15 | 8.4 | ³⁾stable |
| 39 | 35 | 25 | — | — | 100 | 1500 | P-16 | 8.4 | ³⁾stable |
| 40 | 35 | 25 | — | — | 100 | 1500 | P-17 | 8.4 | ³⁾stable |

¹⁾Concentration of the polymer in the solution in percent by weight
²⁾Formation of large active compound crystals, which are deposited, or separation of the active compound from the solution, so that a redispersing by simple stirring or shaking is no longer possible.
³⁾Formation of small active compound particles which are suspended in water. The active compound particles can exhibit amorphous, crystalline or mixed forms of amorphous and crystalline form. No deposition of the active compound can be observed at ambient temperature within a storage time of one month.
C: Comparison test

The following substances were used in formulation examples C41, 42, 43, C44, 45, C46 and 47:
Dispersant: ethylene oxide/propylene oxide triblock copolymer
Wetting agent: naphthalenesulfonic acid/formaldehyde condensation product, sodium salt
Antifreeze agent: propylene glycol
Antifoam agent: silicone-based antifoam agent Silfoam from Wacker
Thickener: xanthan gum
Bactericide: substituted isothiazolin-3-one (Acticide MBS from Thor Chemie)
Polymer P: polymer P-5 from preparation example 5
Fatty alcohol alkoxylate: ethoxylate-co-propoxylate of a C₁₂-C₁₄-alkanol

### Examples C41, 42 and 43

### Preparation of Suspension Concentrates According to the Invention by a Milling Process, General Specification

65.3 parts by weight (or 68.3 parts in comparative example C41) of deionized water were introduced into a vessel having a stirrer. Subsequently, 3 parts by weight of dispersant, 4 parts by weight of wetting agent, 2 parts by weight of antifreeze agent, 0.5 part by weight of antifoam agent and, if appropriate, 3 parts by weight of polymer P (polymer P-5) were added. After complete dispersing, epoxiconazole was added as powder with stirring. The crude dispersion was then premilled using a colloid mill and subsequently milled on a bead mill to the desired final degree of fineness. The auxiliaries still absent, 0.2 part by weight of bactericide and 2 parts by weight of thickener, were then incorporated in this fine suspension.

No polymer P was added in example C41.

Polymer P-5 was added after the milling in example 43.

The formulations were stored at 40° C. The particle size distribution of the active compounds in the samples before and after storing were determined, after diluting with water, by means of laser light scattering (PSD, Malvern Mastersizer 2000 apparatus). The results are collated in table 4. In table 4, d₅₀ is the volume-average particle diameter, determined by light scattering. The d₉₀ value is the particle diameter which 90% by volume of the particles fall below.

TABLE 4

| | Example C41 | Example 42 | Example 43 |
|---|---|---|---|
| PSD before storing | | | |
| d₅₀ | 1.15 μm | 1.15 μm | 1.17 μm |
| d₉₀ | 2.32 μm | 2.28 μm | 2.38 μm |
| PSD after storing | | | |
| d₅₀ | 1.35 μm | 1.18 μm | 1.32 μm |
| d₉₀ | 4.8 μm | 2.5 μm | 2.75 μm |

C = comparative example

### Example C44

### Suspension Concentrates with Boscalid and without Polymer P (not According to the Invention)

The preparation was carried out analogously to the specification given for example C41. The suspension concentrate obtained exhibited the following composition:

| | | |
|---|---|---|
| Boscalid | 500 | g/l |
| Propylene glycol | 70 | g/l |
| Wetting agent | 20 | g/l |
| Dispersant | 30 | g/l |
| Antifoam agent | 5 | g/l |
| Thickener | 2 | g/l |
| Bactericide | 2 | g/l |

| | |
|---|---|
| Water | q.s. for 1 liter |

### Example 45

### Suspension Concentrates with Boscalid and with Polymer P

The preparation was carried out analogously to the specification given for example 42. The suspension concentrate obtained exhibited the following composition:

| | | |
|---|---|---|
| Boscalid | 500 | g/l |
| Propylene glycol | 70 | g/l |
| Wetting agent | 20 | g/l |
| Dispersant | 30 | g/l |
| Polymer P-5 | 30 | g/l |
| Antifoam agent | 5 | g/l |
| Thickener | 2 | g/l |
| Acticide MBS | 2 | g/l |

| | |
|---|---|
| Water | q.s. for 1 liter |

The suspension was examined with regard to particle size after every milling operation, as described above for examples C41, 42 and 43. In addition, samples were stored each time for 12 weeks at 20° C., 30° C., 40° C. and 50° C. and the particle size was subsequently determined by means of light scattering. The results are collated in table 5.

TABLE 5

| | Example C44 | Example 45 |
|---|---|---|
| Particle size distribution | d₅₀ = 1.5 μm | d₅₀ = 1.3 μm |
| after 5 passes through the | d₉₀ = 3.9 μm | d₉₀ = 3.2 μm |
| mill | | |
| Particle size distribution | d₅₀ = 1.2 μm | |
| after 7 passes through the | d₉₀ = 3.0 μm | |
| mill | | |
| Particle size distribution | d₅₀ = 1.5 μm | d₅₀ = 1.4 μm |
| before storing | d₉₀ = 3.4 μm | d₉₀ = 3.3 μm |
| Mean particle size | | |
| after storing for 12 weeks at | | |
| 20° C. | d₅₀ = 1.8 μm | d₅₀ = 1.4 μm |
| 30° C. | d₅₀ = 2.1 μm | d₅₀ = 1.5 μm |
| 40° C. | d₅₀ = 2.4 μm | d₅₀ = 1.7 μm |
| 50° C. | d₅₀ = 2.6 μm | d₅₀ = 1.9 μm |
| Particle size distribution | | |
| after storing for 12 weeks at | | |
| 20° C. | d₉₀ = 4.6 μm | d₉₀ = 3.3 μm |
| 30° C. | d₉₀ = 6.6 μm | d₉₀ = 3.5 μm |
| 40° C. | d₉₀ = 8.8 μm | d₉₀ = 4.0 μm |
| 50° C. | d₉₀ = 10.3 μm | d₉₀ = 5.0 μm |

It follows, from the data in table 5, that the time for the fine milling can be reduced by addition of the polymer P during the milling since approximately 2 fewer passes through the mill are necessary to achieve the same degree of fineness (d₅₀<1.5 μm; d₉₀<3.5 μm). Furthermore, the particle growth during storage at different temperatures was retarded.

### Example C46

### Suspension Concentrates with Boscalid, Epoxiconazole and Adjuvant and Without Polymer P (not According to the Invention)

The preparation was carried out analogously to the specification given for example C41. The suspension concentrate obtained exhibited the following composition:

| | | |
|---|---|---|
| Boscalid | 230 | g/l |
| Epoxiconazole | 50 | g/l |
| Fatty alcohol alkoxylate | 150 | g/l |
| Propylene glycol | 70 | g/l |
| Wetting agent | 30 | g/l |
| Dispersant | 20 | g/l |
| Antifoam agent | 8 | g/l |
| Thickener | 2 | g/l |
| Bactericide | 2 | g/l |

| | |
|---|---|
| Water | q.s. for 1 liter |

### Example 47

### Suspension Concentrates with Boscalid, Epoxiconazole and Adjuvant and with Polymer P

The preparation was carried out analogously to the specification given for example 42, the fatty alcohol alkoxylate having been comilled. The suspension concentrate obtained exhibited the following composition:

| | | |
|---|---|---|
| Boscalid | 230 | g/l |
| Epoxiconazole | 50 | g/l |
| Fatty alcohol alkoxylate | 150 | g/l |
| Propylene glycol | 70 | g/l |
| Wetting agent | 30 | g/l |
| Dispersant | 20 | g/l |
| Polymer P-5 | 20 | g/l |
| Antifoam agent | 8 | g/l |
| Thickener | 2 | g/l |
| Bactericide | 2 | g/l |

| | |
|---|---|
| Water | q.s. for 1 liter |

The suspension concentrates were examined with regard to the particle size as described above for examples C41, 42 and 43. In addition, samples were stored each time for 12 weeks at 20° C., 30° C. and 40° C. and the particle size was subsequently determined by means of light scattering. The results are collated in table 6.

TABLE 6

| | Example C46 | Example 47 |
|---|---|---|
| Particle size distribution | d₉₀ = 5.3 μm | d₉₀ = 5.3 μm |
| before storing | | |
| Particle size distribution | | |
| after storing for 12 weeks at | | |
| 20° C. | d₉₀ = 7.4 μm | d₉₀ = 5.2 μm |
| 30° C. | d₉₀ = 10.7 μm | d₉₀ = 6.6 μm |
| 40° C. | d₉₀ = 14.0 μm | d₉₀ = 11.2 μm |

1-33. (canceled)

34. A method of stabilizing an organic active compound that is sparingly soluble in water in an aqueous composition comprising a surface active substance, the method comprising adding copolymers P which are formed from monoethylenically unsaturated monomers M comprising:
i) 50 to 90% by weight, based on the total weight of the monomers M, of at least one monomer M1 chosen from acrylic acid and methacrylic acid; and
ii) 5 to 50% by weight, based on the total weight of the monomers M, of one or more nonionic monomers M2 which are selected from the group consisting of C₁-C₄-alkyl acrylates, C₁-C₄-alkyl methacrylates, N—C₁-C₃-alkylamides of acrylic acid or of methacrylic acid, N,N-di-D₁-C₃-alkylamides of acrylic acid or of methacrylic acid, vinyl esters of aliphatic C₁-C₃-carboxylic acids and C₁-C₃-alkyl vinyl ethers,
the monomers M1 and M2 constituting at least 70% by weight of the monomers M,
to the aqueous composition.

35. The method of claim 34, wherein the copolymer P exhibits a degree of neutralization of 0 to 90%, based on the carboxyl groups present in the homo- or copolymer P.

36. The method of claim 34, wherein the copolymer P exhibits a weight-average molecular weight in the range from 500 to 200,000 daltons.

37. (canceled)

38. (canceled)

39. (canceled)

40. The method of claim 34, wherein the monomers M2 are selected from methyl acrylate and methyl methacrylate.

41. (canceled)

42. The method of claim 34, wherein the monomers M comprise
i) from 50 to 95% by weight, based on the total weight of the monomers M, of at least one monomer M1 and,
ii) from 5 up to 50% by weight, based on the total weight of the monomers M, of at least one monomer M2.

43. The method of claim 34, wherein the homo- or copolymer P is used in an amount of 5 to 2000% by weight, based on the active compound to be stabilized.

44. The method of claim 34, wherein the composition comprises at least one surface-active substance exhibiting one or more poly-C₂-C₄-alkylene ether groups.

45. The method of claim 34, wherein the surface-active substance comprises at least one block copolymer exhibiting one or more poly-C₂-C₄-alkylene ether groups and at least one polymer chain formed from monoethylenically unsaturated monomers.

46. The method of claim 34, wherein the composition comprises the surface-active substance in an amount of 0.1 to 10 parts by weight, based on 1 part by weight of the active compound.

47. The method of claim 34, wherein the active compound is chosen from active compounds for plant protection.

48. The method of claim 34, wherein the active compound is chosen from the group consisting of azole fungicides, carboxamides and strobilurins.

49. An active compound composition, comprising:
a) at least one copolymer P which is formed from monoethylenically unsaturated monomers M comprising:
i) 50 to 95% by weight, based on the total weight of the monomers M, of at least one monomer M1 chosen from acrylic acid and methacrylic acid; and
ii) 5 to 50% by weight, based on the total weight of the monomers M, of one or more nonionic monomers M2, which are selected from the group consisting of C₁-C₄-alkyl acrylates, C₁-C₄-alkyl methacrylates, N—C₁-C₃-alkylamides of acrylic acid or of methacrylic acid, N,N-di-D₁-C₃-alkylamides of acrylic acid or of methacrylic acid, vinyl esters of aliphatic C₁-C₃-carboxylic acids and C₁-C₃-alkyl vinyl ethers,
the monomers M1 and M2 constituting at least 70% by weight of the monomers M,
b) at least one surface-active substance, and
c) at least one organic active compound which is sparingly soluble in water.

50. The active compound composition of claim 49 in the form of an aqueous active compound composition.

51. The active compound composition of claim 49, wherein the composition comprises:
a) from 0.01 to 15% by weight of the at least one copolymer P,
b) from 1 to 50% by weight of the at least one surface-active substance,
c) from 0.1 to 80% by weight of the at least one organic active compound, and
d) optionally water.

52. The active compound composition of claim 49, wherein the at least one surface-active substance exhibits one or more poly-C₂-C₄-alkylene ether groups.

53. The active compound composition of claim 49, wherein the at least one surface-active substance comprises at least one amphiphilic copolymer exhibiting one or more poly-C₂-C₄-alkylene ether groups and at least one polymer chain formed from monoethylenically unsaturated monomers.

54. The active compound composition of claim 49, comprising the at least one surface-active substance in an amount of 0.1 to 10 parts by weight, based on 1 part by weight of the active compound.

55. The active compound composition of claim 49, wherein the at least one active compound is selected from active compounds for plant protection.

56. The active compound composition of claim 55, wherein the at least one active compound is selected from the group consisting of azole fungicides, carboxamides and strobilurins.

57. An aqueous active compound preparation, comprising:
a) the at least one copolymer P as defined in claim 49,
b) at least one surface-active substance,
c) at least one organic active compound for plant protection which is sparingly soluble in water, and
d) water.

58. The active compound preparation of claim 57, comprising from 0.01 to 5% by weight of the at least one copolymer P, based on the total weight of the active compound preparation.

59. A method for combating phytotoxic organisms comprising using the active compound preparation of claim 57.

60. A method for dispersing an organic active compound which is sparingly soluble in water in aqueous compositions comprising using the copolymers P as defined in claim 34.

61. The method of claim 60, wherein the copolymer P is used in an amount of 0.05 to 20 parts by weight, based on 1 part by weight of the active compound.

62. The method of claim 60, wherein the active compound is chosen from active compounds for plant protection.

63. The method of claim 60, wherein the active compound is selected from active compounds from the group consisting of azole fungicides, carboxamides and strobilurins.

64. A process for the preparation of an aqueous dispersion of an organic active compound which is sparingly soluble in water, comprising mixing an aqueous solution of the copolymer P as defined in claim 34 with a solution of the active compound in an organic solvent and removing the organic solvent.

65. A process for the preparation of an aqueous dispersion of an organic active compound which is sparingly soluble in water, comprising milling an aqueous suspension of the active compound in an aqueous solution of the copolymer P as defined in claim 34.

66. An aqueous dispersion of an organic active compound which is sparingly soluble in water, which is obtained by the process of claim 64.
